(19) United States
(12) Patent Application Publication
(10) Pub. No.: US 2026/0161556 A1
(43) Pub. Date: Jun. 11, 2026

(54) STORAGE SYSTEM AND METHOD OF OPERATING THE SAME

(71) Applicant: SAMSUNG ELECTRONICS CO., LTD., Suwon-si (KR)

(72) Inventors: Soojun IM, Suwon-si (KR); Kyungduk LEE, Suwon-si (KR); Youngjo PARK, Suwon-si (KR)

(73) Assignee: SAMSUNG ELECTRONICS CO., LTD., Suwon-si (KR)

(21) Appl. No.: 19/381,061

(22) Filed: Nov. 6, 2025

(30) Foreign Application Priority Data
Dec. 5, 2024 (KR) 10-2024-0179426

(51) Int. Cl. G06F 12/02

(52) U.S. Cl. CPC G06F 12/0292; G06F 2212/1036; G06F 2212/2022; G06F 2212/7201

(57) ABSTRACT

A storage system includes a storage device and a host device. The storage device includes a nonvolatile memory device configured to store data and a storage controller configured to control the nonvolatile memory device to isolate and store the data by grouping a storage space of the nonvolatile memory device into a plurality of isolation storage spaces. The host device includes a file system configured to generate and manage a plurality of file allocation instances corresponding to a plurality of file allocation system calls from application programs by allocating a logical address range and an isolation identifier of a plurality of isolation identifiers corresponding to the plurality of isolation storage spaces, with respect to each file allocation system call of the plurality of file allocation system calls.

### CROSS-REFERENCE TO RELATED APPLICATION

This U.S. non-provisional application claims priority under 35 USC § 119 to Korean Patent Application No. 10-2024-0179426, filed on Dec. 5, 2024, in the Korean Intellectual Property Office (KIPO), the disclosure of which is incorporated by reference herein in its entirety.

### BACKGROUND

### 1. Technical Field

Example embodiments relate generally to semiconductor integrated circuits, and more particularly to a storage system and a method of operating a storage system.

### 2. Discussion of the Related Art

When a write request is received from a host device, a storage device including a nonvolatile memory device maps a logical address included in a write request to a physical address. The storage device writes the received data to a storage space corresponding to the physical address of the nonvolatile memory device. The nonvolatile memory device performs a write operation and a read operation in units of pages, and may perform an erase operation in units of memory blocks. The nonvolatile memory device cannot overwrite data once stored, but instead erases a memory block in which invalid data is stored and then writes new data to the erased free block. Accordingly, when data with similar properties are scattered and stored in multiple memory blocks, i.e., data is fragmented, the characteristics of the storage device may deteriorate. The fragmented data increases program-erase cycles due to garbage collection, etc., thereby shortening the lifespan of the storage device and degrading the performance of the storage device.

### SUMMARY

Some example embodiments may provide a storage system and a method of operating a storage system, capable of efficiently reducing data fragmentation.

According to example embodiments, a storage system includes a storage device and a host device. The storage device includes a nonvolatile memory device configured to store data and a storage controller configured to control the nonvolatile memory device to isolate and store the data by grouping a storage space of the nonvolatile memory device into a plurality of isolation storage spaces. The host device includes a file system configured to generate and manage a plurality of file allocation instances corresponding to a plurality of file allocation system calls from application programs by allocating a logical address range and an isolation identifier of a plurality of isolation identifiers corresponding to the plurality of isolation storage spaces, with respect to each file allocation system call of the plurality of file allocation system calls.

According to example embodiments, a method of operating a storage system, includes, receiving, by a file system of a host device, a plurality of file allocation system calls from application programs, allocating, by the file system, a logical address range, with respect to each file allocation system call of the plurality of file allocation system calls, allocating, by the file system, an isolation identifier of a plurality of isolation identifiers corresponding to a plurality of isolation storage spaces of a storage device, with respect to each file allocation system call, generating, by the file system, a file allocation instance including an allocated logical address range and an allocated isolation identifier, with respect to each file allocation system call, transferring, from the host device to the storage device, a write request including write data, a write logical address, and a write isolation identifier corresponding to the write logical address based on a plurality of file allocation instances corresponding to the plurality of file allocation system calls, and storing, by the storage device, the write data in an isolation storage space corresponding to the write isolation identifier included in the write request.

According to example embodiments, a storage system includes a storage device including a nonvolatile memory device configured to store data and a storage controller configured to control the nonvolatile memory device to isolate and store the data by grouping a storage space of the nonvolatile memory device into a plurality of isolation storage spaces, and a host device including a file system configured to generate and manage a plurality of file allocation instances corresponding to a plurality of file allocation system calls from application programs by allocating a logical address range and an isolation identifier of a plurality of isolation identifiers corresponding to the plurality of isolation storage spaces, with respect to each file allocation system call of the plurality of file allocation system calls. The host device is not to transfer the plurality of file allocation instances to the storage device, and configured to transfer an isolation identifier corresponding to write data that is to be stored in the storage device. The storage device is configured to store the write data in an isolation storage space corresponding to the write isolation identifier transferred from the host device.

The storage system and the method of operating the storage system according to example embodiments may efficiently reduce data fragmentation through host-driven data isolation storage such that the file allocation instances are generated and managed by the file system of the host device. Through the host device-driven data isolation storage, a larger number of isolation spaces may be allocated than the isolation storage spaces provided by the storage device. By reducing data fragmentation, the efficiency of data access and the efficiency of garbage collection may be improved, thereby improving the performance and lifespan of the storage device.

### BRIEF DESCRIPTION OF THE DRAWINGS

Example embodiments of the present disclosure will be more clearly understood from the following detailed description taken in conjunction with the accompanying drawings.

FIG. 1 is a block diagram illustrating a storage system according to example embodiments.

FIG. 2 is a flowchart illustrating a method of operating a storage system according to example embodiments.

FIG. 3 is a diagram illustrating an example embodiment of a file system implemented in the storage system of FIG. 1.

FIG. 4 is a diagram illustrating an example structure of a system metadata generated by the file system of FIG. 3.

FIG. 5 is a sequence diagram illustrating a method of operating a storage system according to example embodiments.

FIG. 6 is a diagram illustrating information generated and managed by a host device and a storage device included in a storage system according to example embodiments.

FIG. 7 is a diagram illustrating an example embodiment of a file allocation instance generated and managed by a host device according to example embodiments.

FIG. 8 is a block diagram illustrating a storage controller included in a storage device according to example embodiments.

FIG. 9 is a block diagram illustrating an example embodiment of a nonvolatile memory device included in a storage device according to example embodiments.

FIG. 10 is a block diagram illustrating a storage device according to example embodiments.

FIG. 11 is a circuit diagram illustrating an equivalent circuit of a memory block of a nonvolatile memory device included in a storage device according to example embodiments.

FIG. 12 is a diagram illustrating an example embodiment of a first mapping table generated and managed by a host device according to example embodiments.

FIG. 13 is a diagram illustrating an example embodiment of a second mapping table generated and managed by a storage device according to example embodiments.

FIG. 14 is a diagram illustrating an example embodiment of a third mapping table generated and managed by a storage device according to example embodiments.

FIGS. 15 and 16 are diagrams illustrating an example embodiment of generating a file allocation instance in a storage system according to example embodiments.

FIG. 17 is a flowchart illustrating an example embodiment of generating and managing a file allocation instance by a host device according to the example embodiments.

FIGS. 18 through 21 are diagrams illustrating examples of generating and managing a file allocation instance by the host device according to the example embodiments.

FIG. 22 is a diagram illustrating an example embodiment of deleting a file allocation instance by a host device according to example embodiments.

FIGS. 23 and 24 are diagrams illustrating an example embodiment of merging file allocation instances by a host device according to example embodiments.

FIG. 25 is a diagram illustrating an example embodiment of merging file allocation instances by a host device according to example embodiments.

FIG. 26 is a flowchart illustrating an operation of a host device included in a storage system according to example embodiments.

FIG. 27 is a flowchart illustrating an operation of a storage device included in a storage system according to example embodiments.

FIGS. 28 and 29 are diagrams illustrating a UFS Protocol Information Unit (UPIU) used in a storage system according to example embodiments.

FIG. 30 is a diagram illustrating an example embodiment of a packet used in a storage system according to example embodiments.

FIG. 31 is a block diagram illustrating a data center including a storage system according to example embodiments.

### DETAILED DESCRIPTION OF THE EXAMPLE EMBODIMENTS

Various example embodiments will be described more fully hereinafter with reference to the accompanying drawings, in which some example embodiments are shown. In the drawings, like numerals refer to like elements throughout. The repeated descriptions may be omitted.

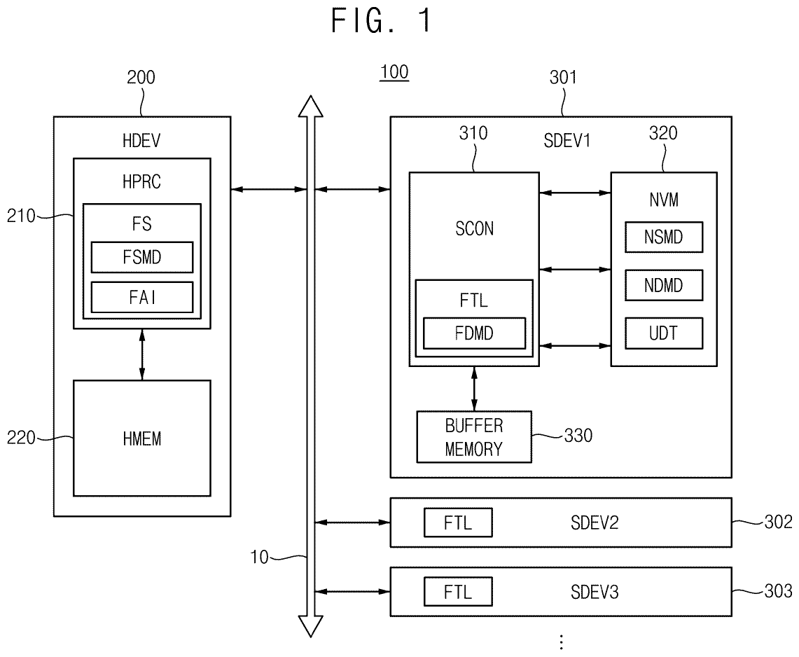

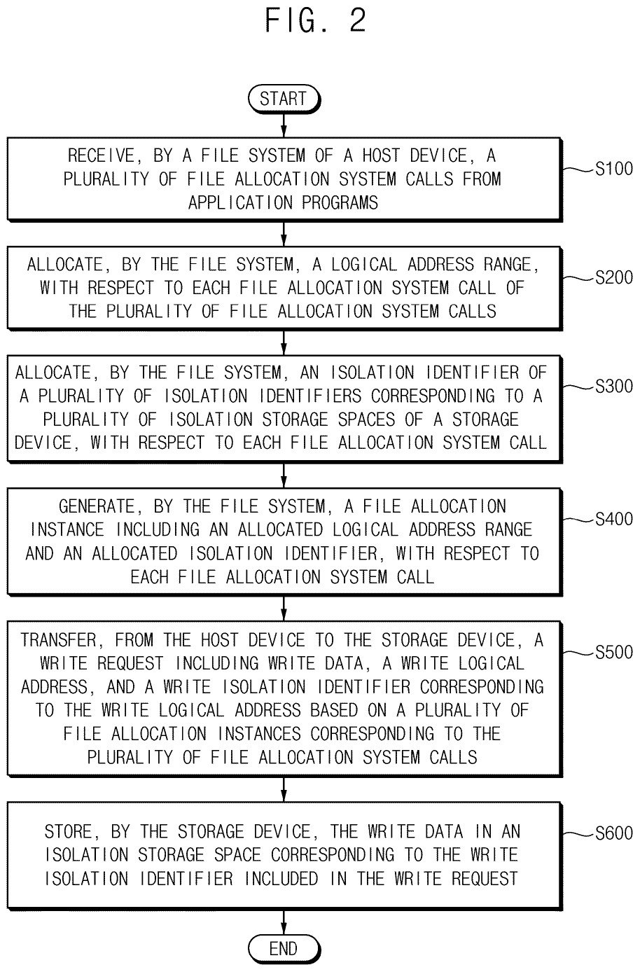

FIG. 1 is a block diagram illustrating a storage system according to example embodiments, and FIG. 2 is a flowchart illustrating a method of operating a storage system according to example embodiments.

Referring to FIG. 1, a storage system 100 may include an interconnector 10, a host device (HDEV) 200, and one or more storage devices (SDEV1, SDEV2 and SDEV3) 301, 302 and 303.

The host device 200 and the storage devices 301, 302 and 303 may be connected to the interconnector 10 and may communicate signals and/or data through the interconnector 10. The interconnector 10 may be referred to as a network fabric. The interconnector 10 may be connected to any suitable networking protocol and/or medium, such as Ethernet, Fibre Channel, InfiniBand, or the like, either directly or through an intermediary device, such as a switch, hub, or the like, which may be a portion of the interconnector 10. The host device 200 may be implemented with any other communication or interconnect protocol that may enable communication between storage devices, such as universal flash storage (UFS), peripheral component interconnect express (PCIe), Serial ATA (SATA), Serial Attached SCSI (SAS), OcuLink, or the like.

The host device 200 controls overall operations of the storage system 100. The host device 200 may include a host processor (HPRC) 210 and host memory (HMEM) 220.

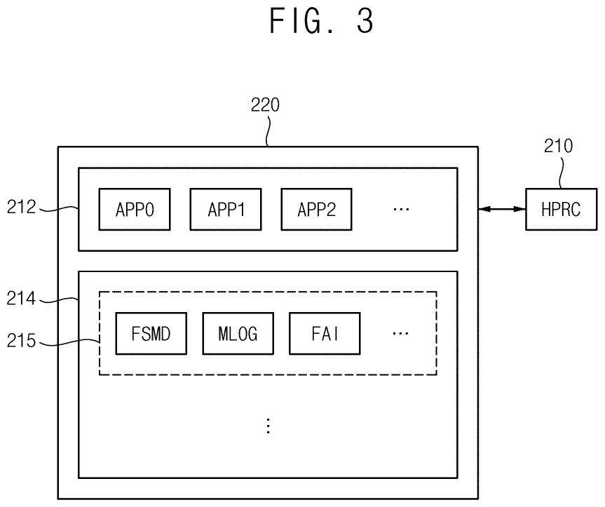

The host processor 210 executes software (applications, operating systems, device drivers, etc.). The host processor 210 may execute an operating system (OS) that is loaded into the host memory device 220. The file system FS may be implemented as software executed by the host processor 210 as a portion of the operating system, as will be described below with reference to FIG. 3. The host processor 210 may also execute various applications to be run on top of the operating system. The host processor 210 may be provided as a homogeneous multi-core processor or a heterogeneous multi-core processor. A multi-core processor is a computing component having at least two independently operable processor cores (hereinafter referred to as cores). Each of the cores may independently read and execute program instructions.

The host memory 220 may store instructions and data that are executed and processed by the host processor 210. For example, the host memory 220 may be loaded with an operating system or applications during booting stage. For example, upon booting of the storage system 100, an operating system stored in at least one of the plurality of storage devices 301, 302 and 303 may be loaded into the host memory 220, and the applications may be subsequently loaded into the host memory 220 by the operating system. Further, the host memory 220 may store system metadata FSMD and file allocation instances FAI generated and managed by the file system FS. The file allocation instances FAI may be considered as a portion of the system metadata FSMD.

As will be described below, the file system FS may generate and manage a plurality of file allocation instances FAI corresponding to a plurality of file allocation system calls from application programs by allocating a logical address range and an isolation identifier of a plurality of isolation identifiers corresponding to a plurality of isolation storage spaces of the nonvolatile memory device 320, with respect to each file allocation system call of the plurality of file allocation system calls.

While three storage devices are shown in FIG. 1 for convenience of illustration and description, example embodiments are not limited to a specific number of storage devices. In an example embodiment, the storage system may include only one storage device, and example embodiments are described herein with reference to one storage device 301. Other storage devices 302 and 303 may have the same or similar configurations as the storage device 301.

The storage device 301, which is accessed by host device 200, may include a storage controller (SCON) 310, at least one nonvolatile memory device (hereinafter may be referred to briefly as nonvolatile memory) (NVM) 320, and a buffer memory 330.

The storage controller 310 may control the operation of the storage device 301. For example, the storage controller 310 may control the operation of the nonvolatile memory device 320 based on requests (or commands) and data received from the host device 200. As will be described below, the storage controller 310 may control the nonvolatile memory device 320 to isolate and store the data by grouping a storage space of the nonvolatile memory device 320 into a plurality of isolation storage spaces.

The nonvolatile memory device 320 may store a variety of data. For example, the nonvolatile memory device 320 may store system metadata NSMD, device metadata NDMD, and user data UDT.

The system metadata NSMD may be distinct from the device metadata NDMD.

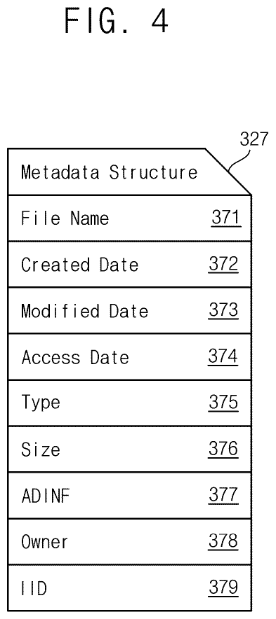

The system metadata NSMD is data that is created and updated by the file system FS to manage data stored in the nonvolatile memory device 320. The system metadata NSMD is discussed further with reference to FIG. 4.

The system metadata may be loaded from the nonvolatile memory device 320 during power-on process of the storage system 100 and stored in a volatile memory (e.g., host memory 220), such as DRAM or SRAM, of the host device 200. The system metadata stored in the nonvolatile memory device 320 may be referred to as nonvolatile system metadata NSMD, and the system metadata stored in the host device 200 may be referred to as firmware system metadata FSMD. The firmware system metadata FSMD may change during operation of the host device 200, and journaling techniques may be employed to maintain consistency between the firmware system metadata FSMD and the nonvolatile system metadata NSMD.

The device metadata NDMD, on the other hand, is data that the storage device 301 generates and updates by the firmware of the storage controller 310 for address translation of the nonvolatile memory device 320, management of bad memory blocks, and the like. The device metadata NDMD may include a mapping table that represents a mapping relationship between logical addresses of the host device 1100 and physical addresses of the nonvolatile memory device 320. The mapping table may be generated and updated by the flash translation layer FTL. In addition, the flash translation layer FTL may include other information for managing memory space.

The device metadata may be loaded from the nonvolatile memory device 320 during power-on process of the storage system 100 and stored in a volatile memory (e.g., buffer memory 330) such as DRAM, SRAM, etc. in the storage controller 310. The device metadata stored in the nonvolatile memory device 320 may be referred to as nonvolatile device metadata NDMD, and the device metadata stored in the storage controller 310 or buffer memory 330 may be referred to as firmware device metadata FDMD. The firmware device metadata FDMD may change during operation of the storage device 301, and journaling techniques may be employed to maintain consistency between the firmware device metadata FDMD and the nonvolatile device metadata NDMD.

In an example embodiment, the nonvolatile memory device 320 may include NAND flash memory. In other example embodiments, the nonvolatile memory device 320 may include Electrically Erasable Programmable Read-Only Memory (EEPROM), Phase Change Random Access Memory (PRAM), Resistance Random Access Memory (RRAM), Nano Floating Gate Memory (NFGM), and/or Polymer Random Access Memory (PoRAM), MRAM.

The buffer memory 330 may store instructions and data executed and processed by the storage controller 310, and may temporarily store data stored or desired to be stored in the nonvolatile memory device 320, as well as data read from the nonvolatile memory device 320. For example, the buffer memory 330 may include volatile memory, such as static random access memory (SRAM), dynamic random access memory (DRAM), or the like.

In an example embodiment, the storage device 301 may be a universal flash storage (UFS), a solid state drive (SSD), a multi-media card (MMC), or an embedded MMC (eMMC). In another example embodiment, the storage device 301 may be implemented as a Secure Digital (SD) card, micro SD card, memory stick, chip card, Universal Serial Bus (USB) card, smart card, Compact Flash (CF) card, or the like.

In an example embodiment, the storage device 301 may be connected to the host device 200 via the interconnector 10, which may include a Serial Advanced Technology Attachment (SATA) bus, Small Computer Small Interface (SCSI) bus, Nonvolatile Memory Express (NVMe) bus, Serial Attached SCSI (SAS) bus, UFS, eMMC, or other bus, and may be accessed by host device 200 on a block-by-block basis via a block-accessible interface.

Referring to FIGS. 1 and 2, the file system FS of the host device 200 may receive a plurality of file allocation system calls from application programs (S100).

The file system FS may allocate a logical address range, with respect to each file allocation system call of the plurality of file allocation system calls (S200).

The file system FS may allocate an isolation identifier of a plurality of isolation identifiers corresponding to a plurality of isolation storage spaces of the storage device 320, with respect to each file allocation system call (S300).

The file system FS may generate a file allocation instance FAI including an allocated logical address range and an allocated isolation identifier, with respect to each file allocation system call (S400).

The host device 200 may transfer, to the storage device 301, a write request including write data, a write logical address, and a write isolation identifier corresponding to the write logical address based on a plurality of file allocation instances FAI corresponding to the plurality of file allocation system calls (S500).

The storage device 301 may store the write data in an isolation storage space corresponding to the write isolation identifier included in the write request (S600).

FIG. 2 illustrates the overall operation method of the storage system 100 for isolating data storage. Example embodiments for each processes illustrated in FIG. 2 will be described in more detail with reference to FIGS. 2 through 30.

As such, the storage system 100 and the method of operating the storage system 100 according to example embodiments may efficiently reduce data fragmentation through host-driven data isolation storage such that the file allocation instances FAI are generated and managed by the file system FS of the host device 200. Through the host device-driven data isolation storage, a larger number of isolation spaces may be allocated than the isolation storage spaces provided by the storage device 301. By reducing data fragmentation, the efficiency of data access and the efficiency of garbage collection may be improved, thereby improving the performance and lifespan of the storage device 301.

FIG. 3 is a diagram illustrating an example embodiment of a file system implemented in the storage system of FIG. 1.

FIG. 3 illustrates an exemplary software structure of the storage system 100 of FIG. 1. Referring to FIG. 3, the software hierarchy of the storage system 100 loaded into the host memory 220 and driven by the host processor 210 may be roughly divided into applications 212 and a kernel 214 of an operating system. The operating system may further include device drivers to manage various devices such as memory, modems, and image processing devices.

The application programs (APP0, APP1 and APP2) 212 (hereinafter briefly referred to as applications) are higher-level software that may run as basic services or be triggered by user requests. The applications 212 may be running simultaneously to provide various services. The applications 212 may be executed by the host processor 210 after being loaded into the host memory 220 of FIG. 1.

The kernel 214 is a component of the operating system that performs control operations between the applications 212 and the hardware. The kernel 214 may include program execution, interrupts, multitasking, memory management, file systems, and device drivers. According to example embodiments, only the file system 215 provided as a portion of the kernel 214 will be described.

The user space, where the applications 212 resides, and the kernel space, where the kernel 214 resides, including the file system 215, input/output scheduler, device drivers, and the like, may be separate from each other. The applications 212 may not have direct access to resources such as the storage device 301 of FIG. 1. Instead, the applications 212 may call functions defined on a library (not shown) that includes system call functions and may request the necessary operations from the kernel 214. When the system call function is called, a transition from user mode to kernel mode may occur.

The file system 215 may manage files or data (user data) stored in the storage device 301. For example, the file system 215 may include a file allocation table (FAT), new technology file system (NTFS), hierarchical file system (HFS), high performance file system (HPFS), unix file system (UFS), secondary extended file system (ext2), ext3, ext4, journaling file system (JFS), ISO 9660, Files-11, veritas file system (VxFS), ZFS, ReiserFS, universal disk format (UDF), and the like. The file system 215 may perform journaling to prevent databases, files, or data from becoming inconsistent due to a sudden power off (SPO) or system crash.

While the file system 215 stores data in the nonvolatile memory device 320 of the storage device 301, the file system 215 may generate system metadata FSMD used to manage the data and store the generated metadata FSMD as a data structure in the nonvolatile memory device 320. The file system 215 may also store the system metadata FSMD in the host memory 220. The file system 215 may store changes to files, if any, in a metalog MLOG.

According to embodiments, the file system FS may generate and manage the file allocation instances FAI. The file system FS may generate and manage the file allocation instances FAI by allocating a logical address range and allocating one of the plurality of isolation identifiers corresponding to the plurality of isolation storage spaces of the nonvolatile memory device 320 to each of file allocation system calls from the application programs 212.

As mentioned above, the file allocation instances FAI may be included in the system metadata FSMD. The system metadata FSMD may be distinguished from device metadata that the storage device 301 manages for address translation of the nonvolatile memory device 320, management of bad memory blocks, and the like.

FIG. 4 is a diagram illustrating an example structure of a system metadata generated by the file system of FIG. 3. FIG. 4 illustrates a system metadata structure corresponding to a single file.

Referring to FIG. 4, the metadata structure 327 may include various data fields.

These data fields may include a file name 371, a created date 372 when the file was created (as used herein, the term ‘date’ is intended to include both date and time), a modified date 373 when the file was last changed, an access date 374 when the file was last accessed, a type 375 for the file (e.g., executable, document, text file, or other), a size 376 of the file, address information (ADINF) 377, an owner 378 of the file, and an isolation identifier 379.

The aforementioned file allocation instances FAI may be included in the system metadata FSMD as a separate data structure distinct from the metadata structure 327 corresponding to the file of FIG. 4.

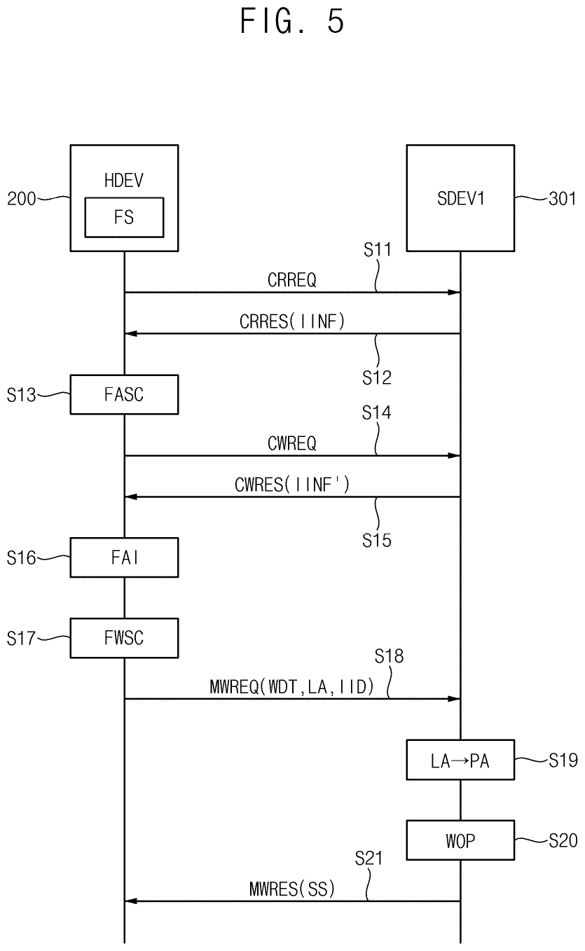

FIG. 5 is a sequence diagram illustrating a method of operating a storage system according to example embodiments.

Referring to FIGS. 1 and 5, a file system FS of a host device 200 may transmit a configuration read request CRREQ to a storage device 301 (S11). The configuration read request CRREQ may be a request requesting isolation information IINF indicating a plurality of isolation storage spaces of a nonvolatile memory device 320 and sizes of the plurality of isolation storage spaces. In an example embodiment, the size of the isolation storage space may indicate the number of memory blocks allocated to the isolation storage space. The storage device 301 may transmit a configuration read response CRRES including the requested isolation information IINF to the host device 200 (S12).

The file system FS may receive a file allocation system call FASC from an application program (S13). For example, the file allocation system call FASC may be “fallocate” of Linux. “fallocate” creates a file that occupies a certain size of logical address space in advance without actually storing data. “fallocate” may include a file descriptor and a logical address range. In an example embodiment, the logical address range may be expressed by a start (or offset) address and an address length (or size).

According to example embodiments, the file system FS may, if necessary, transmit a configuration write request CWREQ to the storage device 301 (S14). The configuration write request CWREQ may be a request requesting expansion or reduction of the isolation storage space of the nonvolatile memory device 320. The storage device 301 may change the isolation information IINF according to the request of the host device 200 and transmit a configuration write response CWRES including the changed isolation information IINF′ to the host device 200 (S15). The file system FS of the host device 200 may generate a file allocation instance FAI corresponding to the received file allocation system call FASC based on the isolation information IINF or IINF′ provided from the storage device 301 (S16).

Thereafter, the file system FS may receive a file write system call FWSC from the application program (S17). For example, the file write system call FWSC may be “fwrite” of Linux. “fwrite” may include a file descriptor, a logical address range, etc. In response to this file write system call FWSC, a write operation that actually stores data in the nonvolatile memory device 320 may be performed.

The host device 200 may transmit a memory write request MWREQ including write data WDT, a write logical address LA, and an isolation identifier IID to the storage device 301 (S18). The flash translation layer FTL of the storage device 301 may map a write logical address LA to a physical address PA of an isolation storage space corresponding to the isolation identifier IID based on the isolation identifier IID (S19). The storage device 301 may perform a write operation WOP to store write data WDT in a storage area corresponding to the physical address PA of the nonvolatile memory device (S20). If the write operation WOP is successfully completed, the storage device 301 may transmit a memory write response MWRES including write success information SS to the host device 200 (S21). As described with reference to FIG. 5, the host device 200 may transmit an isolation identifier IID corresponding to the write data WDT to the storage device 301 when storing the write data WDT in the storage device 301 without transmitting the file allocation instances FAI to the storage device 301. The storage device 301 only performs address mapping to correspond to the isolation identifier IID, and the generation and management of the isolation identifier IID are led by the file system FS of the host device 200. This host-driven data isolation storage may be efficiently applied without changing the existing storage standard. Therefore, the host device-driven data isolation storage according to the example embodiments may be easily applied to storage systems adopting various standards.

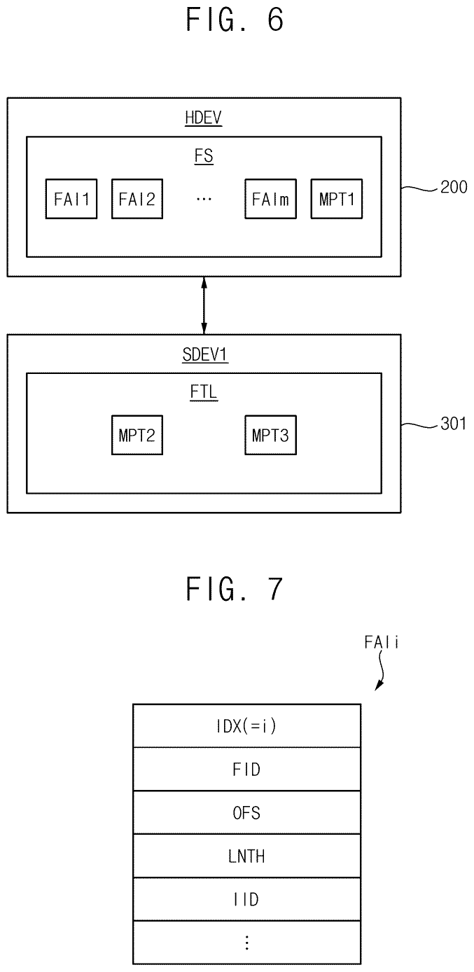

FIG. 6 is a diagram illustrating information generated and managed by a host device and a storage device included in a storage system according to example embodiments, and FIG. 7 is a diagram illustrating an example embodiment of a file allocation instance generated and managed by a host device according to example embodiments.

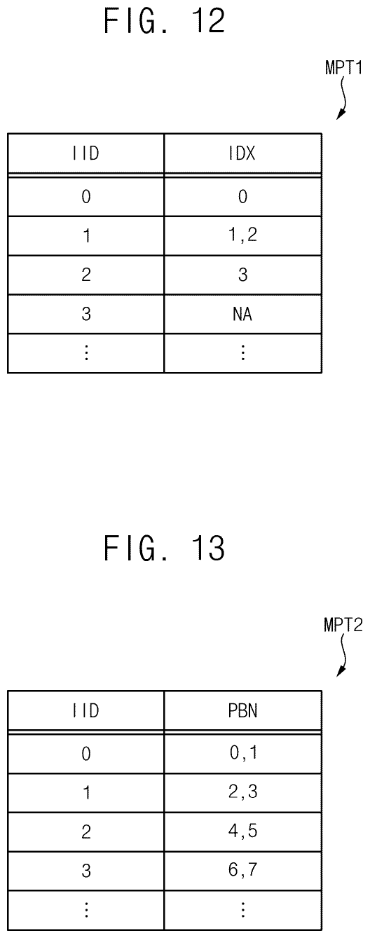

Referring to FIG. 6, a file system FS of a host device 200 may include a plurality of file allocation instances FAI1 to FAIm and a first mapping table MPT1. As described below with reference to FIG. 12, the first mapping table MPT1 may indicate a mapping relationship between isolation identifiers IID and file allocation instances FAI. According to example embodiments, the first mapping table MPT1 may be omitted.

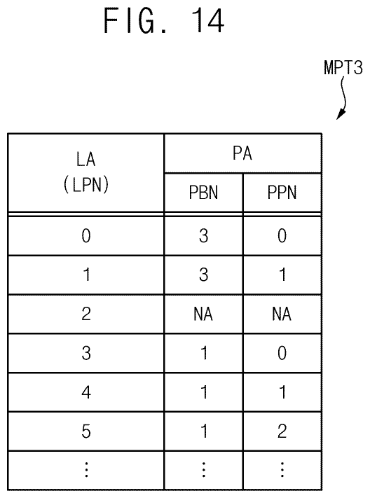

A flash translation layer FTL of the host device 200 may include a second mapping table MPT2 and a third mapping table MPT3. As will be described below with reference to FIG. 13, the second mapping table MPT2 may indicate a mapping relationship between the isolation identifiers IID and the storage spaces (for example, memory blocks) of the nonvolatile memory device 320. As will be described below with reference to FIG. 14, the third mapping table MPT3 may indicate a mapping relationship between the logical addresses LA of the host device 200 and the physical addresses PA of the nonvolatile memory device 320.

The plurality of file allocation instances FAI1 to FAIm and the first mapping table MPT1 correspond to system metadata generated and updated by the file system FS. On the other hand, the second mapping table MPT2 and the third mapping table MPT3 correspond to device metadata generated and updated by the firmware of the storage controller 310.

FIG. 7 illustrates information included in each file allocation instance FAIi. Referring to FIG. 7, a file allocation instance FAIi may include an index IDX, a file identifier FID, a start (or offset) address PFS, an address length (or size) LNTH, and an isolation identifier IID.

The index IDX indicates a serial number of the file allocation instance FAIi. The file identifier FID indicates a serial number of a corresponding file. The start address PFS and the address length LNTH indicate the aforementioned logical address range allocated by the file system FS. The isolation identifier IID indicates an isolation storage space of the nonvolatile memory device 320 allocated by the file system FS.

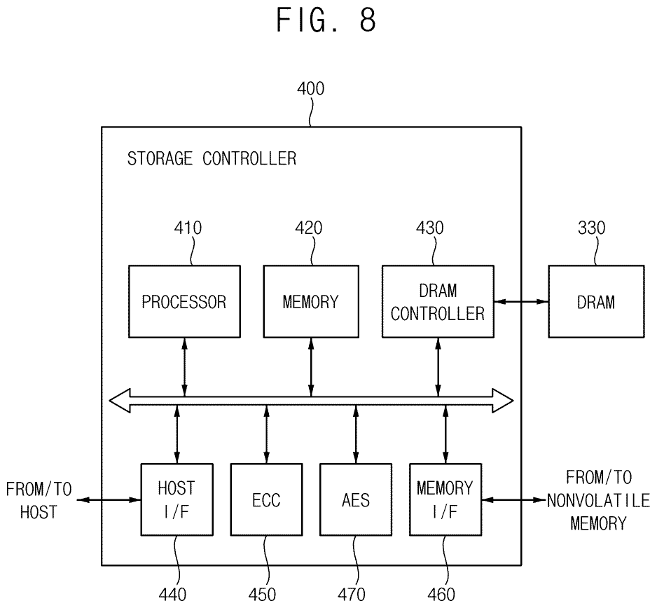

Hereinafter, a storage device implemented with a flash memory will be described with reference to FIGS. 8 through 11. Example embodiments are not limited to flash memory and may be applied to a storage system including any nonvolatile memory.

FIG. 8 is a block diagram illustrating a storage controller included in a storage device according to example embodiments.

Referring to FIG. 8, a storage controller 400 may include a processor 410, a memory 420, a DRAM controller (DRM) 430, a host interface (I/F) 440, an error correction code (ECC) engine 450, a memory interface (I/F) 460 and an advanced encryption standard (AES) engine 470.

The processor 410 may control an operation of the storage controller 400 in response to a command received via the host interface 440 from a host device (e.g., the host device 200 in FIG. 1). For example, the processor 410 may control an operation of a storage device (e.g., the first storage device 301 in FIG. 1), and may control respective components by employing firmware for operating the storage device.

The memory 420 may store instructions and data executed and processed by the processor 410. For example, the memory 420 may be implemented with a volatile memory, such as a DRAM, a SRAM, a cache memory, or the like.

The processor 410 may access an external DRAM 330 through the DRAM controller 430. The processor 410 may control the DRAM controller 430, the memory interface 460, and the host interface 440 to transmit user data stored in the external DRAM 430 to the nonvolatile memory device 301 or to an external host device.

The ECC engine 450 for error correction may perform coded modulation using a Bose-Chaudhuri-Hocquenghem (BCH) code, a low density parity check (LDPC) code, a turbo code, a Reed-Solomon code, a convolution code, a recursive systematic code (RSC), a trellis-coded modulation (TCM), a block coded modulation (BCM), etc., or may perform ECC encoding and ECC decoding using above-described codes or other error correction codes.

The host interface 440 may provide physical connections between the host device and the storage device. The host interface 440 may provide an interface corresponding to a bus format of the host device for communication between the host device and the storage device. In some example embodiments, the bus format of the host device may be a small computer system interface (SCSI) or a serial attached SCSI (SAS) interface. In other example embodiments, the bus format of the host device may be a USB, a peripheral component interconnect (PCI) express (PCIe), an advanced technology attachment (ATA), a parallel ATA (PATA), an SATA, a nonvolatile memory (NVM) express (NVMe), etc., format.

The memory interface 460 may communicate data with a nonvolatile memory (e.g., the nonvolatile memories 320 in FIG. 1). The memory interface 460 may transfer data to the nonvolatile memory, or may receive data read from the nonvolatile memory. In some example embodiments, the memory interface 460 may be connected to the nonvolatile memory via one channel. In other example embodiments, the memory interface 460 may be connected to the nonvolatile memory via two or more channels. For example, the memory interface 460 may be configured to comply with a standard protocol, such as Toggle or open NAND flash interface (ONFI).

The AES engine 470 may perform at least one of an encryption operation and a decryption operation on data input to the storage controller 400 using a symmetric-key algorithm. The AES engine 470 may include an encryption module and a decryption module. For example, the encryption module and the decryption module may be implemented as separate modules. For another example, one module capable of performing both encryption and decryption operations may be implemented in the AES engine 470.

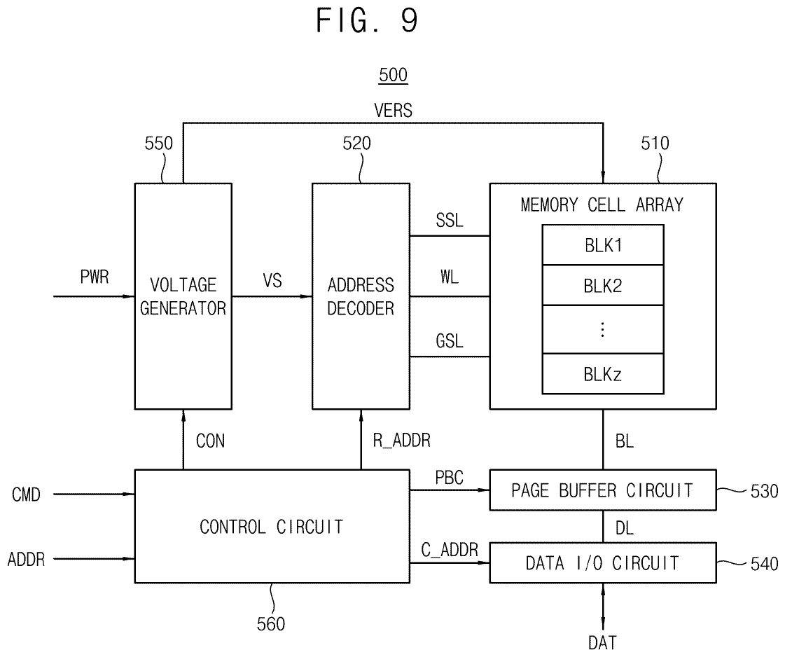

FIG. 9 is a block diagram illustrating an example embodiment of a nonvolatile memory device included in a storage device according to example embodiments.

Referring to FIG. 9, a nonvolatile memory 500 includes a memory cell array 510, an address decoder 520, a page buffer circuit 530, a data I/O circuit 540, a voltage generator 550 and a control circuit 560.

The memory cell array 510 is connected to the address decoder 520 via a plurality of string selection lines SSL, a plurality of wordlines WL and a plurality of ground selection lines GSL. The memory cell array 510 is further connected to the page buffer circuit 530 via a plurality of bitlines BL. The memory cell array 510 may include a plurality of memory cells (e.g., a plurality of nonvolatile memory cells) that are connected to the plurality of wordlines WL and the plurality of bitlines BL. The memory cell array 510 may be divided into a plurality of memory blocks BLK1, BLK2, . . . , BLKz, each of which includes memory cells. In addition, each of the plurality of memory blocks BLK1, BLK2, . . . , BLKz may be divided into a plurality of pages.

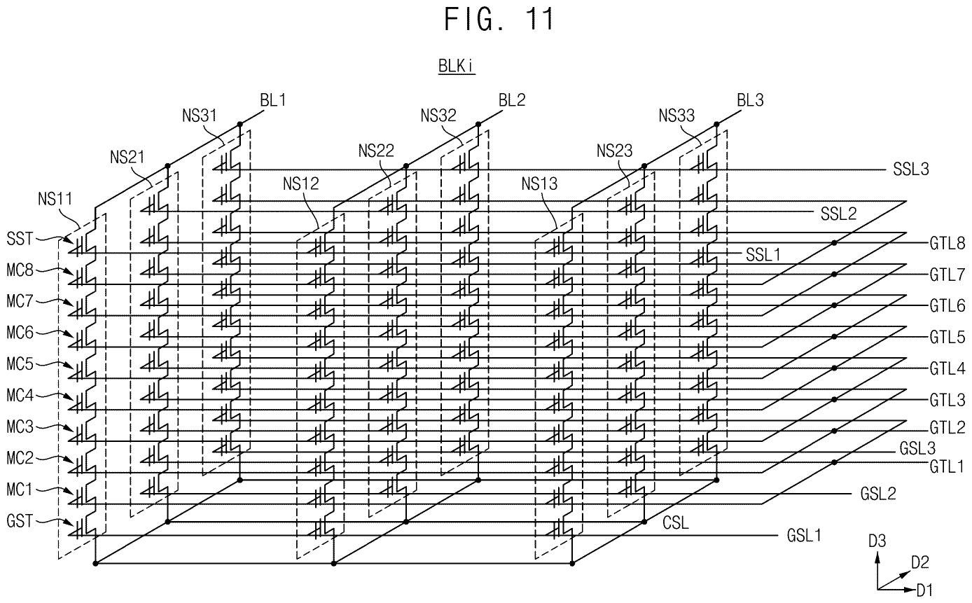

In some example embodiments, the plurality of memory cells included in the memory cell array 510 may be arranged in a two-dimensional (2D) array structure or a three-dimensional (3D) array structure (e.g., a 3D vertical array structure). The memory cell array of the 3D array structure will be described below with reference to FIG. 11.

The control circuit 560 receives a command CMD and an address ADDR from an outside (e.g., from the storage controller 310 in FIG. 1), and controls erasure, programming and read operations of the nonvolatile memory 500 based on the command CMD and the address ADDR. An erasure operation may include performing a sequence of erase loops, and a program operation may include performing a sequence of program loops. Each program loop may include a program operation and a program verification operation. Each erase loop may include an erase operation and an erase verification operation. The read operation may include a normal read operation and data recover read operation.

For example, the control circuit 560 may generate control signals CON, which are used for controlling the voltage generator 550, and may generate control signal PBC for controlling the page buffer circuit 530, based on the command CMD, and may generate a row address R_ADDR and a column address C_ADDR based on the address ADDR. The control circuit 560 may provide the row address R_ADDR to the address decoder 520 and may provide the column address C_ADDR to the data I/O circuit 540.

The address decoder 520 may be connected to the memory cell array 510 via the plurality of string selection lines SSL, the plurality of wordlines WL and the plurality of ground selection lines GSL.

For example, in the data erase/write/read operations, the address decoder 520 may determine at least one of the plurality of wordlines WL as a selected wordline, and may determine the remaining wordlines, other than the selected wordline, as unselected wordlines, based on the row address R_ADDR.

In addition, in the data erase/write/read operations, the address decoder 520 may determine at least one of the plurality of string selection lines SSL as a selected string selection line, and may determine the remaining string selection lines, other than the selected string selection line, as unselected string selection lines, based on the row address R_ADDR.

Further, in the data erase/write/read operations, the address decoder 520 may determine at least one of the plurality of ground selection lines GSL as a selected ground selection line, and may determine the remaining ground selection lines, other than the selected ground selection line, as unselected ground selection lines, based on the row address R_ADDR.

The voltage generator 550 may generate voltages VS that are required for an operation of the nonvolatile memory 500 based on a power PWR and the control signals CON. The voltages VS may be applied to the plurality of string selection lines SSL, the plurality of wordlines WL and the plurality of ground selection lines GSL via the address decoder 520. In addition, the voltage generator 550 may generate an erase voltage that is required for the data erase operation based on the power PWR and the control signals CON. The erase voltage may be applied to the memory cell array 510 directly or via the bitline BL.

For example, during the erase operation, the voltage generator 550 may apply the erase voltage to a common source line and/or the bitline BL of a memory block (e.g., a selected memory block) and may apply an erase permission voltage (e.g., a ground voltage) to all wordlines of the memory block or a portion of the wordlines via the address decoder 520. In addition, during the erase verification operation, the voltage generator 550 may apply an erase verification voltage simultaneously to all wordlines of the memory block or sequentially to the wordlines one by one.

For example, during the program operation, the voltage generator 550 may apply a program voltage to the selected wordline and may apply a program pass voltage to the unselected wordlines via the address decoder 520. In addition, during the program verification operation, the voltage generator 550 may apply a program verification voltage to the selected wordline and may apply a verification pass voltage to the unselected wordlines via the address decoder 520.

In addition, during the normal read operation, the voltage generator 550 may apply a read voltage to the selected wordline and may apply a read pass voltage to the unselected wordlines via the address decoder 520. During the data recover read operation, the voltage generator 550 may apply the read voltage to a wordline adjacent to the selected wordline and may apply a recover read voltage to the selected wordline via the address decoder 520.

The page buffer circuit 530 may be connected to the memory cell array 510 via the plurality of bitlines BL. The page buffer circuit 530 may include a plurality of page buffers. In some example embodiments, each page buffer may be connected to one bitline. In other example embodiments, each page buffer may be connected to two or more bitlines.

The page buffer circuit 530 may store data DAT to be programmed into the memory cell array 510 or may read data DAT sensed (e.g., read) from the memory cell array 510. In other words, the page buffer circuit 530 may operate as a write driver or a sensing amplifier according to an operation mode of the nonvolatile memory 500.

The data I/O circuit 540 may be connected to the page buffer circuit 530 via data lines DL. The data I/O circuit 540 may provide the data DAT from the outside of the nonvolatile memory 500 to the memory cell array 510 via the page buffer circuit 530 or may provide the data DAT from the memory cell array 510 to the outside of the nonvolatile memory 500, based on the column address C_ADDR.

Although the nonvolatile memory is described based on a NAND flash memory, example embodiments are not limited thereto, and the nonvolatile memory may be any nonvolatile memory, e.g., a phase random access memory (PRAM), a resistive random access memory (RRAM), a nano floating gate memory (NFGM), a polymer random access memory (PoRAM), a magnetic random access memory (MRAM), a ferroelectric random access memory (FRAM), a thyristor random access memory (TRAM), or the like.

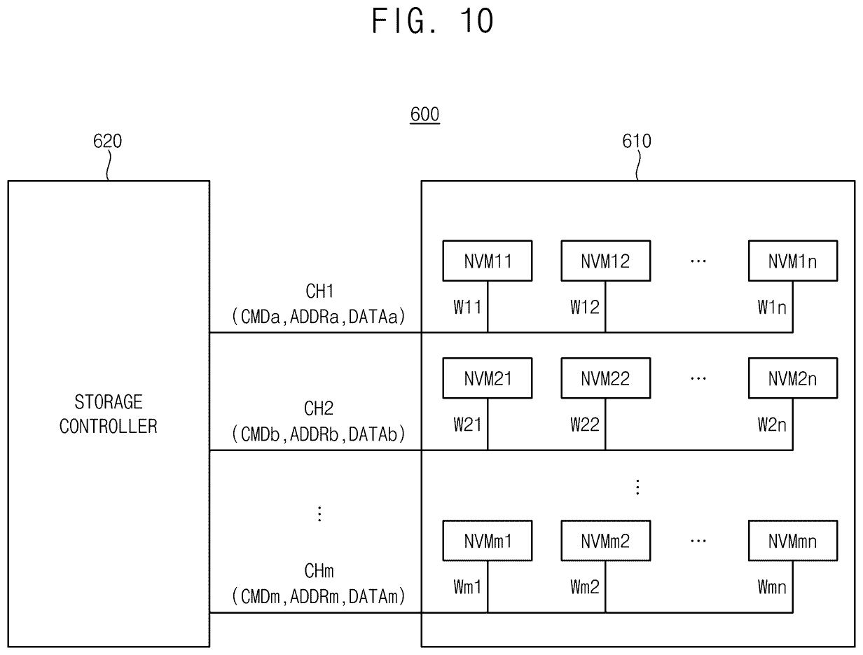

FIG. 10 is a block diagram illustrating a storage device according to example embodiments.

Referring to FIG. 10, a storage device 600 may include a memory device 610 and a storage controller 620. The storage device 600 may support a plurality of channels CH1, CH2, . . . , CHm, and the memory device 610 may be connected to the storage controller 620 through the plurality of channels CH1 to CHm. For example, the storage device 600 may be implemented as a universal flash storage (UFS), a solid state drive (SSD), or the like, and the storage device 600 may correspond to the storage device 301 of FIG. 1.

The memory device 610 may include a plurality of nonvolatile memories NVM11, NVM12, . . . , NVM1n, NVM21, NVM22, . . . , NVM2n, NVMm1, NVMm2, . . . , NVMmn. For example, the nonvolatile memories NVM11 to NVMmn may correspond to the nonvolatile memory device 320a, 320b and 320c in FIG. 1. Each of the nonvolatile memories NVM11 to NVMmn may be connected to one of the plurality of channels CH1 to CHm through a way corresponding thereto. For instance, the nonvolatile memories NVM11 to NVM1n may be connected to the first channel CH1 through ways W11, W12, . . . , W1n, the nonvolatile memories NVM21 to NVM2n may be connected to the second channel CH2 through ways W21, W22, . . . , W2n, and the nonvolatile memories NVMm1 to NVMmn may be connected to the m-th channel CHm through ways Wm1, Wm2, . . . , Wmn. In some example embodiments, each of the nonvolatile memories NVM11 to NVMmn may be implemented as a memory unit that may operate according to an individual command from the storage controller 620. For example, each of the nonvolatile memories NVM11 to NVMmn may be implemented as a chip or a die, but example embodiments are not limited thereto.

The storage controller 620 may transmit and receive signals to and from the memory device 610 through the plurality of channels CH1 to CHm. For example, the storage controller 620 may correspond to the storage controller 310 in FIG. 1. For example, the storage controller 620 may transmit commands CMDa, CMDb, . . . , CMDm, addresses ADDRa, ADDRb, . . . , ADDRm and data DATAa, DATAb, . . . , DATAm to the memory device 610 through the channels CH1 to CHm, or may receive the data DATAa to DATAm from the memory device 610 through the channels CH1 to CHm.

The storage controller 620 may select one of the nonvolatile memories NVM11 to NVMmn, which is connected to one of the channels CH1 to CHm, using a corresponding one of the channels CH1 to CHm, and may transmit and receive signals to and from the selected nonvolatile memory. For example, the storage controller 620 may select the nonvolatile memory NVM11 from among the nonvolatile memories NVM11 to NVM1n connected to the first channel CH1. The storage controller 620 may transmit the command CMDa, the address ADDRa and the data DATAa to the selected nonvolatile memory NVM11 through the first channel CH1 or may receive the data DATAa from the selected nonvolatile memory NVM11 through the first channel CH1.

The storage controller 620 may transmit and receive signals to and from the memory device 610 in parallel through different channels. For example, the storage controller 620 may transmit the command CMDb to the memory device 610 through the second channel CH2 while transmitting the command CMDa to the memory device 610 through the first channel CH1. For example, the storage controller 620 may receive the data DATAb from the memory device 610 through the second channel CH2 while receiving the data DATAa from the memory device 610 through the first channel CH1.

The storage controller 620 may control overall operations of the memory device 610. The storage controller 620 may transmit a signal to the channels CH1 to CHm and may control each of the nonvolatile memories NVM11 to NVMmn connected to the channels CH1 to CHm. For example, the storage controller 620 may transmit the command CMDa and the address ADDRa to the first channel CH1 and may control one selected from among the nonvolatile memories NVM11 to NVM1n.

Each of the nonvolatile memories NVM11 to NVMmn may operate under the control of the storage controller 620. For example, the nonvolatile memory NVM11 may program the data DATAa based on the command CMDa, the address ADDRa and the data DATAa provided from the storage controller 620 through the first channel CH1. For example, the nonvolatile memory NVM21 may read the data DATAb based on the command CMDb and the address ADDRb provided from the storage controller 620 through the second channel CH2 and may transmit the read data DATAb to the storage controller 620 through the second channel CH2.

Although FIG. 10 illustrates an example where the memory device 610 communicates with the storage controller 620 through m channels and includes n nonvolatile memories corresponding to each of the channels, example embodiments are not limited thereto and the number of channels and the number of nonvolatile memories connected to one channel may be variously changed.

FIG. 11 is a circuit diagram illustrating an equivalent circuit of a memory block of a nonvolatile memory device included in a storage device according to example embodiments.

Referring to FIG. 11, each memory block BLKi included in a memory cell array 510 in FIG. 19 may be formed on a substrate in a three-dimensional structure (or a vertical structure). For example, NAND strings or cell strings included in the memory block BLKi may be formed in a vertical direction D3 perpendicular to an upper surface of a substrate. A first direction D1 and a second direction D2 are parallel to the upper surface of the substrate.

The memory block BLKi may include NAND strings NS11 to NS33 coupled between bitlines BL1, BL2, and BL3 and a common source line CSL. Each of the NAND strings NS11 to NS33 may include a string selection transistor SST, a memory cells MC1 to MC8, and a ground selection transistor GST. In FIG. 11, each of the NAND strings NS11 to NS33 is illustrated to include eight memory cells MC1 to MC8. However, example embodiments are not limited thereto, and each of the NAND strings NS11 to NS33 may include various numbers of memory cells.

Each string selection transistor SST may be connected to a corresponding string selection line (one of SSL1 to SSL3). The memory cells MC1 to MC8 may be connected to corresponding gate lines GTL1 to GTL8, respectively. The gate lines GTL1 to GTL8 may be wordlines, and some of the gate lines GTL1 to GTL8 may be dummy wordlines. Each ground selection transistor GST may be connected to a corresponding ground selection line (one of GSL1 to GSL3). Each string selection transistor SST may be connected to a corresponding bitline (e.g., one of BL1, BL2, and BL3), and each ground selection transistor GST may be connected to the common source line CSL.

Wordlines (e.g., WL1) having the same height may be commonly connected, and the ground selection lines GSL1 to GSL3 and the string selection lines SSL1 to SSL3 may be separated. In FIG. 11, the memory block BLKi is illustrated as being coupled to eight gate lines GTL1 to GTL8 and three bitlines BL1 to BL3. However, example embodiments are not limited thereto, and each memory block in the memory cell array 510 may be coupled to various numbers of wordlines and various numbers of bitlines.

FIG. 12 is a diagram illustrating an example embodiment of a first mapping table generated and managed by a host device according to example embodiments.

Referring to FIG. 12, a first mapping table MPT1 may indicate a mapping relationship between isolation identifiers IID and file allocation instances FAI. For example, the first mapping table of FIG. 12 may indicate that an isolation identifier (IID=0) having a value of 0 is assigned to a file allocation instance FAI0 corresponding to an index of 0 (IDX=0), an isolation identifier (IID=1) having a value of 1 is assigned to file allocation instances FAI1 and FAI2 corresponding to an index of 1 (IDX=1) and an index of 2(IDX=2), an isolation identifier (IID=2) having a value of 2 is assigned to a file allocation instance FAI3 corresponding to an index of 3 (IDX=3), and an isolation identifier (IID=3) having a value of 3 is in an unallocated state (NA).

The file system FS may generate and manage the file allocation instances FAI in response to file allocation system calls from application programs, and update the first mapping table MPT1 according to updates to the file allocation instances FAI. According to example embodiments, the first mapping table MPT1 may further include information on logical address ranges of file allocation instances FAI to which each isolation identifier IID is assigned.

According to example embodiments, the first mapping table MPT1 may be omitted. When the first mapping table MPT1 is omitted, the file system FS may perform generation, merging, deletion, etc. of the file allocation instances while referring to all stored file allocation instances.

FIG. 13 is a diagram illustrating an example embodiment of a second mapping table generated and managed by a storage device according to example embodiments, and FIG. 14 is a diagram illustrating an example embodiment of a third mapping table generated and managed by a storage device according to example embodiments.

Referring to FIG. 13, a second mapping table MPT2 may indicate a mapping relationship between isolation identifiers IID and storage spaces (for example, memory blocks) of the nonvolatile memory device 320. For example, in the second mapping table MPT2 of FIG. 13, an isolation identifier (IID=0) having a value of 0 is mapped to memory blocks MB0 and MB1 corresponding to a physical block number (PBN=0) of 0 and a physical block number (PBN=1) of 1, an isolation identifier (IID=1) having a value of 1 is mapped to memory blocks MB2 and MB3 corresponding to a physical block number (PBN=2) of 2 and a physical block number (PBN=3) of 3, an isolation identifier (IID=2) having a value of 2 is mapped to memory blocks MB4 and MB5 corresponding to a physical block number (PBN=4) of 4 and a physical block number (PBN=5) of 5, and an isolation identifier (IID=3) having a value of 3 is mapped to memory blocks MB6 and MB7 corresponding to a physical block number (PBN=6) of 6 and a physical block number (PBN=7) of 7.

Although FIG. 13 illustrates an example of mapping two memory blocks to each isolation identifier IID, the number of memory blocks mapped to each isolation identifier IID may be determined in various ways. According to example embodiments, the number of memory blocks mapped to each isolation identifier IID may maintain a value preset in a storage standard, etc., or may be changed by a request of the file system FS of the host device 200 as described with reference to FIG. 5. Meanwhile, FIG. 13 illustrates an example of sequentially mapping physical block numbers, but the physical block numbers assigned to each isolation identifier IID may be updated over time by garbage collection, etc.

Referring to FIG. 14, a third mapping table MPT3 may indicate a mapping relationship between logical addresses LA of the host device 200 and physical addresses PA of the nonvolatile memory device 320. In an example embodiment, the logical address LA may correspond to a logical page number LPN, and the physical address PA may correspond to a combination of a physical block number PBN and a physical page number PPN. The number of bits of data corresponding to the logical page number LPN and the physical page number PPN may be determined in various ways, such as 4 kB, 8 kB, 16 kB, etc. The number of bits of data corresponding to the logical page number LPN and the physical page number PPN may be the same as or different from the number of bits of a page that is a unit of a read operation and a write operation of a nonvolatile memory device. For example, the third mapping table MPT3 of FIG. 14 may indicate that a logical page number (LPN=0) having a value of 0 is mapped to a physical address (PA=(3, 0)) corresponding to a combination of a physical block number (PBN=3) having a value of 3 and a physical page number (PPN=0) having a value of 0, and that a logical page number (LPN=0) having a value of 1 is mapped to a physical address (PA=(3, 1)) corresponding to a combination of a physical block number (PBN=3) having a value of 3 and a physical page number (PPN=1) having a value of 1. In other words, the third mapping table MPT3 may indicate that write data corresponding to LPN=0, 1 are isolated and stored in a memory block MB3 corresponding to PBN=3. A logical page number (LPN=2) having a value of 2 may indicate an unmapped state (NA). Likewise, the third mapping table MPT3 may indicate that write data corresponding to LPN=3, 4, 5 is isolated and stored in a memory block MB1 corresponding to PBN=1.

In this way, the flash translation layer FTL of the storage device 301 may select a memory block corresponding to an isolation identifier IID provided from the host device 200 by referring to the second mapping table MPT2, and may manage the third mapping table MPT3 by mapping the logical address LA to the physical address PA of the selected memory block.

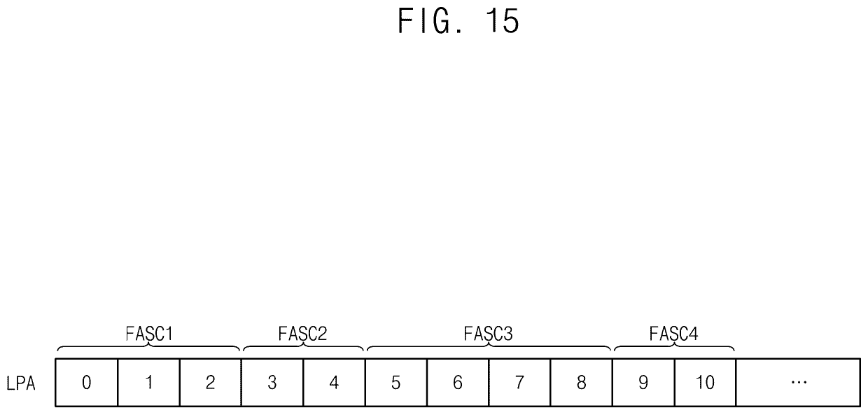

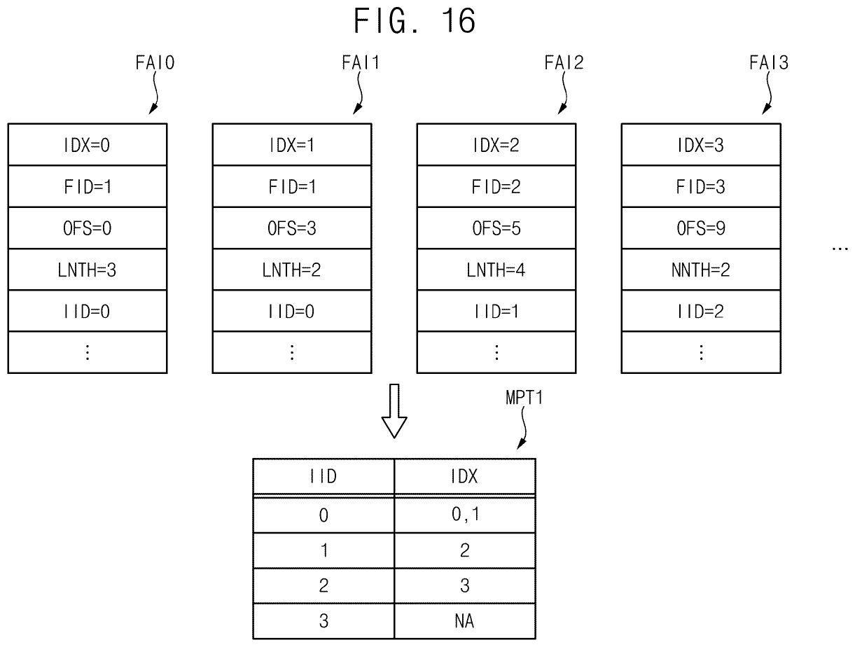

FIGS. 15 and 16 are diagrams illustrating an example embodiment of generating a file allocation instance in a storage system according to example embodiments.

FIG. 15 illustrates an example of allocation of a logical address by a file system FS. Referring to FIG. 15, a logical address range, for example, logical page numbers LPA, may be allocated to file allocation system calls FASC1 to FASC4 from application programs. In the example of FIG. 15, the file system FS may allocate three logical page numbers (LPA=0, 1, 2) to the file allocation system call FASC0, two logical page numbers (LPA=3, 4) to the file allocation system call FASC1, four logical page numbers (LPA=5, 6, 7, 8) to the file allocation system call FASC2, and two logical page numbers (LPA=9, 10) to the file allocation system call FASC3. FIG. 16 illustrates file allocation instances FAI0 to FAI3 and the first mapping table MPT1 corresponding to the allocation of the logical address range of FIG. 15. Hereinafter, descriptions that overlap with the descriptions of the file allocation instances FAIi of FIG. 7 and the first mapping table MPT1 of FIG. 12 will be omitted to avoid redundancy.

In this way, the file system FS of the host device 200 according to the example embodiments may generate and manage file allocation instances by allocating a logical address range and assigning one of a plurality of isolation identifiers IID corresponding to each of the plurality of isolation storage spaces of the nonvolatile memory device 320 to each of the file allocation system calls from the application programs.

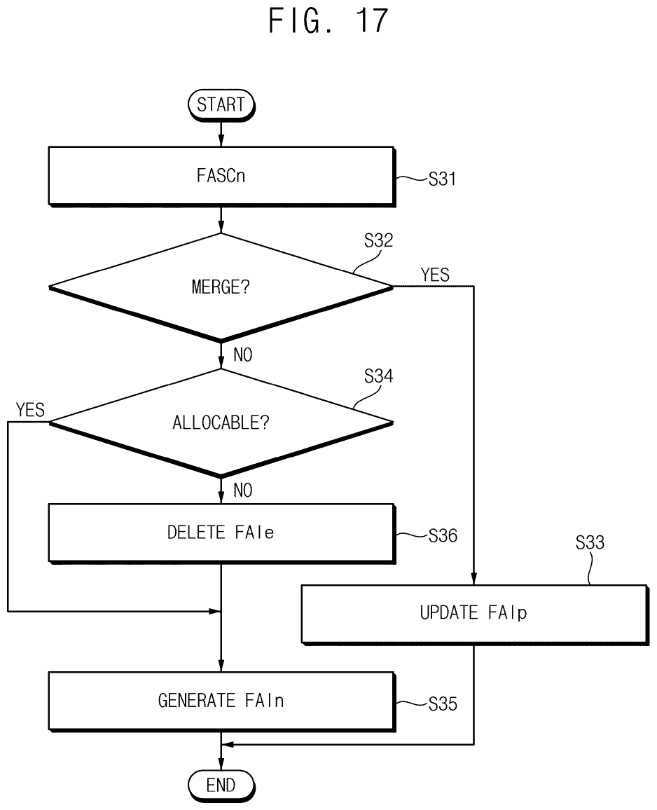

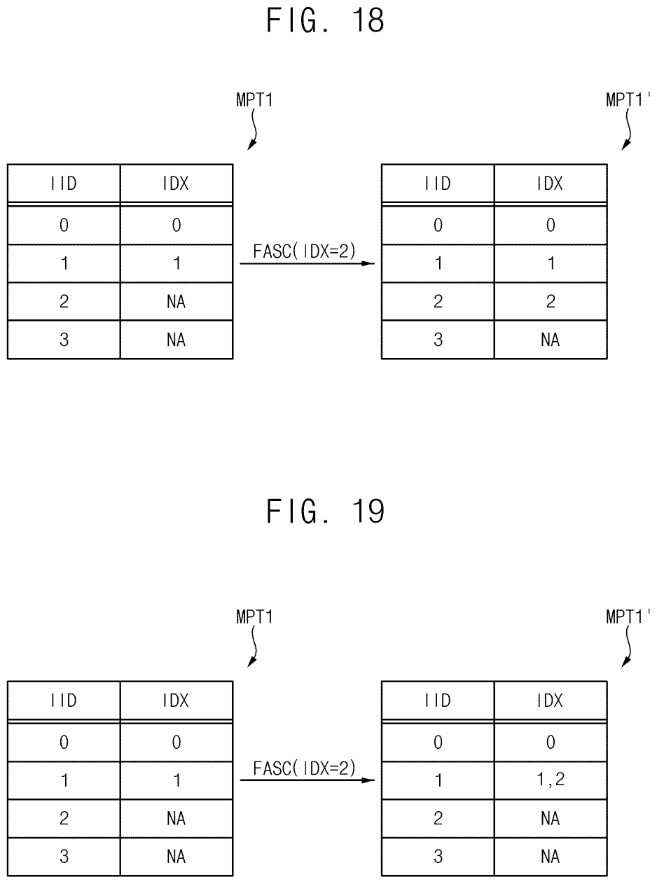

FIG. 17 is a flowchart illustrating an example embodiment of generating and managing a file allocation instance by a host device according to the example embodiments, and FIGS. 18 through 21 are diagrams illustrating examples of generating and managing a file allocation instance by the host device according to the example embodiments. Hereinafter, descriptions that overlap with the descriptions of the file allocation instance FAIi of FIG. 7 and the first mapping table MPT1 of FIG. 12 are omitted to avoid redundancy. In FIGS. 18 through 21, MPT1 represents the first mapping table before update, and MPT1′ and MPT″ represent the first mapping table that is updated after receiving a new file allocation system call.

Referring to FIGS. 1 and 17, the file system FS of the host device 200 may receive a new file allocation system call FASCn from an application program (S31).

The file system FS may determine whether to merge a new file allocation instance for the new file allocation system call FASCn with a previously generated file allocation instance (S32). The file system FS may determine whether to merge two or more file allocation instances corresponding to one file based on the file attributes of the one file. The above file attribute may include at least one of the file name of the one file, the file name extension of the one file, the file size of the one file, and the update cycles of data corresponding to the two or more file allocation instances.

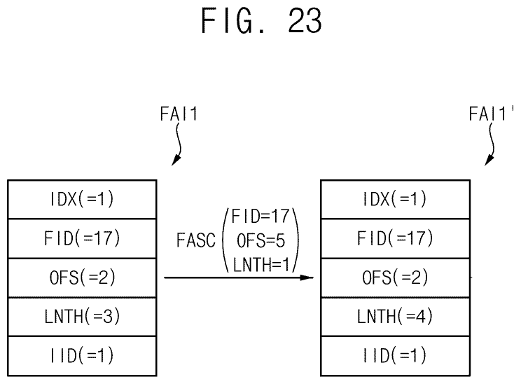

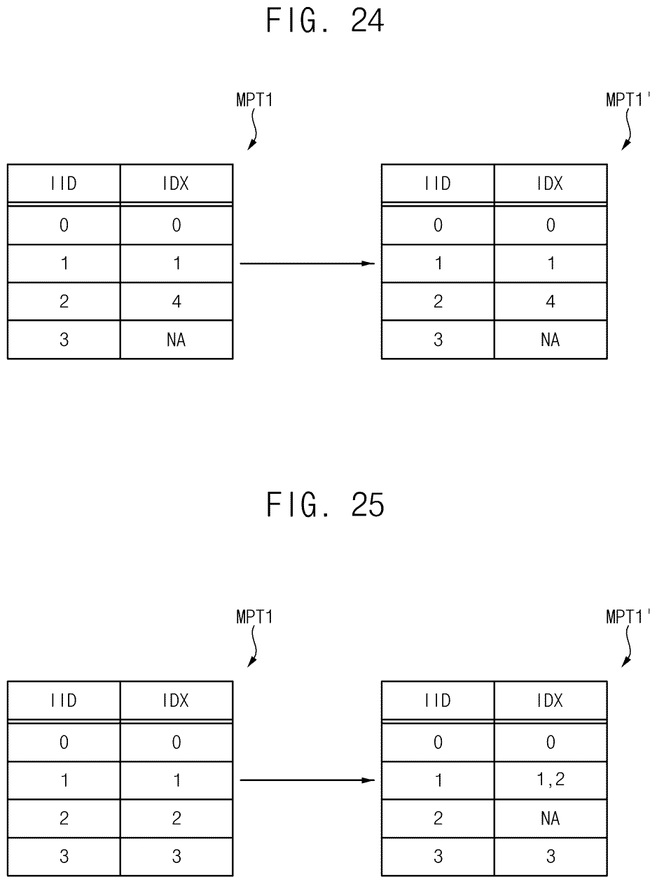

If the file system FS determines to merge the new file allocation instance for the new file allocation system call FASCn with the previous file allocation instance FAIp (S32: YES), the file system FS may update the previous file allocation instance FAIp (S33). The update of the file allocation instance FAIp according to the merge will be described below with reference to FIGS. 23 and 24.

If the file system FS determines not to merge the new file allocation instance for the new file allocation system call FASCn with the previous file allocation instance FAIp (S32: NO), the file system FS may determine whether there is an isolation identifier that is allocable to the new file allocation system call FASCn among the multiple isolation identifiers of the nonvolatile memory device 320 (S34).

For example, as shown in FIG. 18, if there is an isolation identifier (IID=2, 3) in the unallocated state (NA), an allocable isolation identifier (IID=2) may be assigned to the new file allocation system call (FASC(IDX=2)) to generate a new file allocation instance FAIn.

For example, as illustrated in FIG. 19, if an isolation identifier (IID=1) already assigned to another file allocation instance (IDX=1) is duplicated and assigned to a new file allocation instance (IDX=2), it may be determined that an allocable isolation identifier exists. In this case, an allocable isolation identifier (IID=2) may be duplicated and assigned to a new file allocation system call (FASC(IDX=2)) to generate a new file allocation instance FAIn.

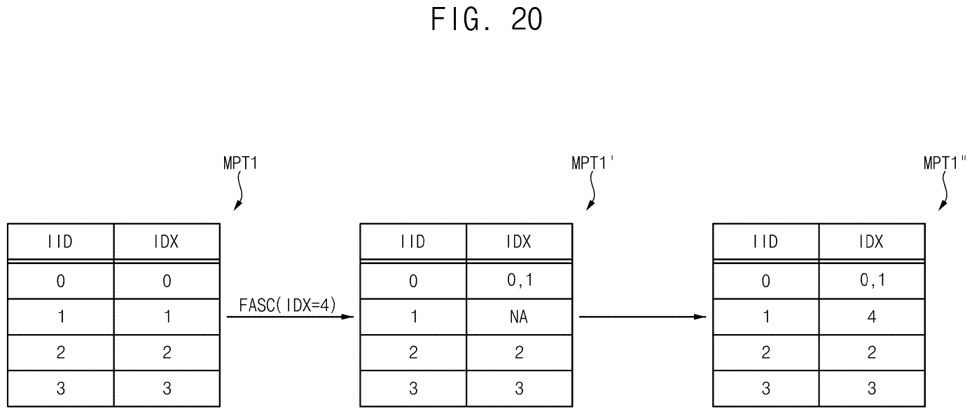

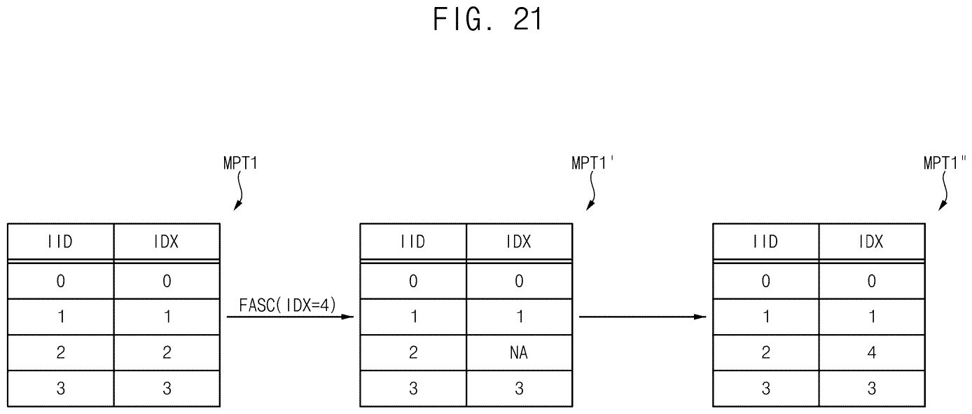

For example, as illustrated in FIG. 20, an isolation identifier (IID=1) in an unallocated state (NA) may be provided by merging the isolation identifiers (IID=0, 1) assigned to two file allocation instances (IDX=0, 1). In this case, a new file allocation instance FAIn may be generated by assigning an isolation identifier (IID=1) of an unallocated state (NA) to a new file allocation system call (FASC(IDX=4)).

As described with reference to FIGS. 18, 19, and 20, if the file system FS determines that an allocable isolation identifier exists (S34: YES), the file system FS may generate a file allocation instance FAIn corresponding to the new file allocation system call FASCn by assigning an allocable isolation identifier (S35).

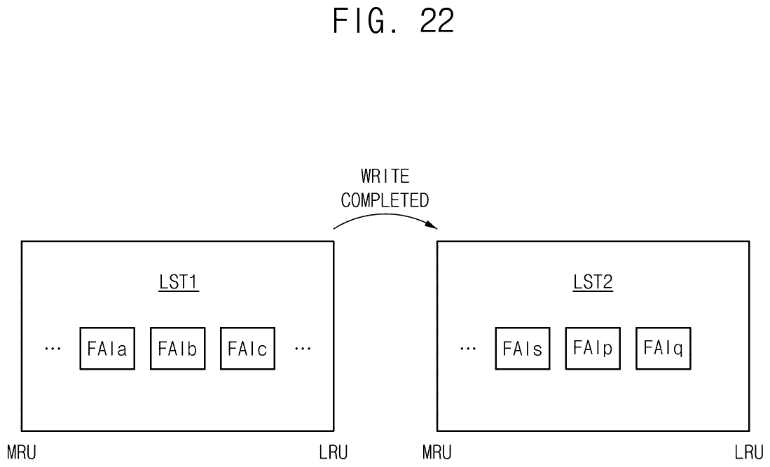

If the file system FS determines that an allocable isolation identifier does not exist (S34: NO), the file system FS may delete one of the previously generated file allocation instances FAIe that has already been generated (S36). Example embodiments of a method for determining an allocable file allocation instance FAIe are described below with reference to FIG. 22.

The file system FS may generate a new file allocation instance FAIn by allocating the isolation identifier assigned to the eviction file allocation instance FAIe to the new file allocation system call FASCn (S35). For example, as illustrated in FIG. 21, the previously generated file allocation instance (IDX=2) may be determined as the eviction file allocation instance FAIe. The isolation identifier (IID=2) assigned to the eviction file allocation instance (IDX=2) may be recovered and may be in an unallocated state (NA). In this case, the isolation identifier (IID=2) of the unallocated state (NA) may be assigned to the new file allocation system call (FASC(IDX=4)) to generate the new file allocation instance FAIn. According to example embodiments, the file system FS of the host device 200 may selectively determine to merge file allocation instances FAIp and FAIn or delete an eviction file allocation instance FAIe when a new file allocation system call is received from an application program. In other words, in an example embodiment, as described with reference to FIG. 17, the merging of file allocation instances FAIp and FAIn may be preferentially attempted, and if the merging of file allocation instances FAIp and FAIn is not possible, the deletion of the eviction file allocation instance FAIe may be performed. In another example embodiment, the deletion of the eviction file allocation instance FAIe may be preferentially attempted, and if the deletion of the eviction file allocation instance FAIe is not possible, the merging of the file allocation instances FAIp and FAIn may be attempted. The file system FS may preferentially perform a more advantageous method among the merging of file allocation instances FAIp and FAIn and the deletion of the eviction file allocation instance FAIe.

FIG. 22 is a diagram illustrating an example embodiment of deleting a file allocation instance by a host device according to example embodiments.

Referring to FIG. 22, a file system FS may generate and manage a first list LST1 and a second list LST2. The file system FS may store file allocation instances FAIa, FAIb and FAIc whose write operations are not completed in the first list LST1 in the order in which the last write operation was performed, that is, in the order from the most recently written (MRU) to the least recently written (LRU). Meanwhile, file allocation instances FAIs, FAIp and FAIq whose write operations are completed may be stored in the second list LST2 in the order in which the last write operation was performed. Among the file allocation instances FAIa, FAIb and FAIc stored in the first list LST1, the file allocation instances whose writing has been completed may be moved from the first list LST1 and stored in the second list LST2.

The file system FS may determine, based on the first list LST1 and the second list LST, the file allocation instance (FAIq in FIG. 22) whose last writing operation has been performed least recently among the file allocation instances whose writing operation has been completed as the evicted file allocation instance (FAIe in FIG. 17) to be deleted.

In an example embodiment, the file system FS may generate and manage an evicted value Ve according to Expression 1 for each file allocation instance.

$$Ve = W 1 \times Rw + W 2 \times Tw \qquad Expression 1$$

In Expression 1, Ve is the eviction value of each file allocation instance, Rw is a ratio of an address range where a write operation is completed with respect to a logical address range allocated to each file allocation instance, Tw is a time elapsed from a time when a last write operation is performed with respect to each file allocation instance, and W1 and W2 are weight values. The weight values W1 and W2 for each of the ratio Rv and the elapsed time Tw may be determined as appropriate values through methods such as simulation and testing.

The file system FS may determine the file allocation instance having the largest eviction value Ve among the previously generated file allocation instances as the eviction file allocation instance (FAIe in FIG. 17) to be deleted.

Meanwhile, if an application program requests to delete all or a portion of a file, the file system may delete the corresponding file allocation instances. In an example embodiment, when the file system FS receives a system call (e.g., “fclose” of Linux) for deleting a file from an application program, the file system FS may delete all file allocation instances corresponding to the file from among the previously generated file allocation instances.

In an example embodiment, when the file system FS receives a system call (e.g., “ftruncate” of Linux) for deleting an allocation of a target logical address range from an application program, the file system may delete a file allocation instance whose allocated logical address range is included in the target logical address range from among the previously generated file allocation instances.

FIGS. 23 and 24 are diagrams illustrating an example embodiment of merging file allocation instances by a host device according to example embodiments.

FIG. 23 illustrates an example of merging a new file allocation system call FASC into a previously generated file allocation instance FAI1 to create an updated file allocation instance FAI1′. In an example embodiment, as illustrated in FIG. 23, if the file identifier (FID=17) is the same and the logical address range is continuous, it may be determined to merge a new file allocation system call FASC into the previous file allocation instance FAI1. When comparing the previous file allocation instance FAI1 and the updated file allocation instance FAI1′, the start address PFS corresponding to the logical address range is the same and the address length LNTH has increased. In other words, the address range (LPN=2, 3, 4, 5) of the updated file allocation instance FAI1′ may increase compared to the address range (LPN=2, 3, 4) of the previous file allocation instance FAI1.

Meanwhile, in the case of such a merge, as illustrated in FIG. 24, the first mapping table MPT1 before the merge and the first mapping table MPT1′ after the merge may be maintained identically. If the first mapping table MPT1 includes a logical address range, the logical address range of the first mapping table MPT1 before merging and the logical address range of the mapping table MPT1′ after merging may be different.

FIG. 25 is a diagram illustrating an example embodiment of merging file allocation instances by a host device according to example embodiments.

In FIG. 25, MPT1 represents the first mapping table before merging and MPT1′ represents the first mapping table after merging. Referring to FIG. 25, the file system FS may merge isolation identifiers (IID=1, 2) assigned to different indexes (IDX=1, 2) even when no new file allocation system call is received. For example, the file system FS may perform merging of such isolation identifiers while the host device 200 is in an idle state in which no access to the storage device 301 is performed. For example, as illustrated in FIG. 25, isolation identifiers (IID=1, 2) assigned to different indexes (IDX=1, 2) may be merged into one isolation identifier (IID=1). In this case, another isolation identifier (IID=2) is switched to an unallocated state (NA), and an isolation identifier (IID=2) in an unallocated state (NA) may be assigned to a file allocation system call received thereafter.

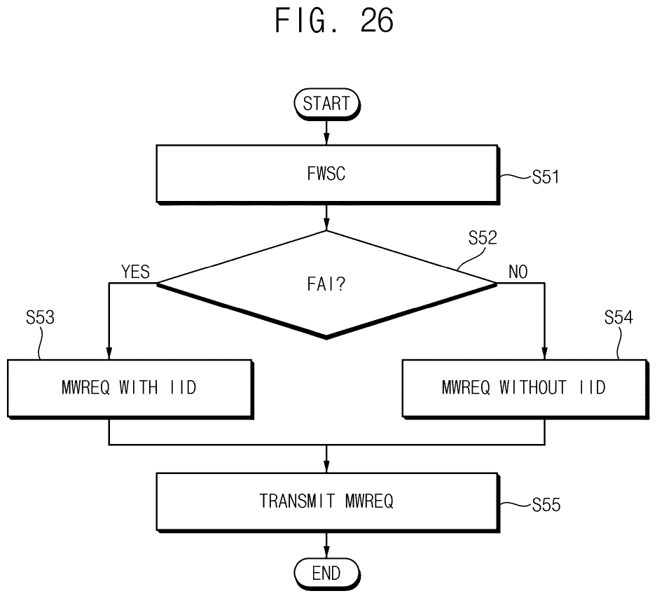

FIG. 26 is a flowchart illustrating an operation of a host device according to example embodiments.

Referring to FIG. 26, the file system FS of the host device 200 may receive a file write system call FWSC from an application program (S51).

The file system FS may determine whether a file allocation instance FAI corresponding to a write logical address range included in the write system call FWSC exists (S52). The file system FS may generate a memory write request MWREQ including an isolation identifier IID corresponding to the write logical address range (S53) if a file allocation instance FAI corresponding to the write logical address range exists (S52: YES).

On the other hand, the file system FS may generate a memory write request MWREQ not including an isolation identifier IID if a file allocation instance FAI corresponding to the write logical address range does not exist (S52: NO).

The host device 200 may transmit the memory write request MWREQ generated in this way to the storage device 301 (S55).

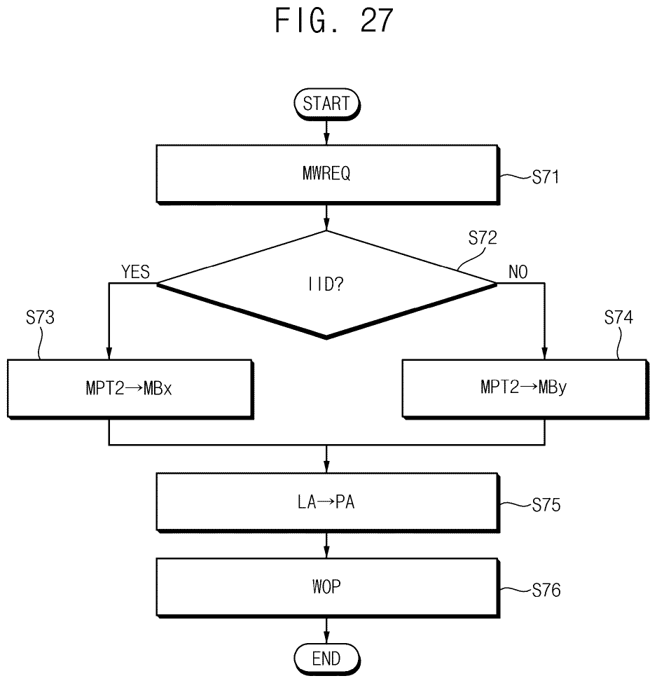

FIG. 27 is a flowchart illustrating an operation of a storage device included in a storage system according to example embodiments.

Referring to FIG. 27, the storage device 301 may receive a memory write request MWREQ from the host device 200 (S71) and determine whether the memory write request MWREQ includes an isolation identifier IID (S72). If the memory write request MWREQ includes an isolation identifier IID (S72: YES), the flash translation layer FTL of the storage device 301 may select a memory block MBx corresponding to the isolation identifier IID by referring to the second mapping table MPT2 of FIG. 13 (S73). Meanwhile, if the memory write request MWREQ does not include an isolation identifier IID (S72: NO), the flash translation layer FTL of the storage device 301 may select a memory block MBy that does not correspond to a plurality of isolation storage spaces by referring to the second mapping table MPT2 of FIG. 13 (S74).

The flash translation layer FTL may map the write logical address LA to the write physical address PA corresponding to the selected memory block (MBx or MBy) (S75).

The storage device 301 may perform a write operation WOP to store write data in the write physical address PA of the selected memory block of the nonvolatile memory device (S76).

As described with reference to FIGS. 26 and 27, when the host device 200 stores write data WDT in the storage device 301 without transmitting file allocation instances FAI to the storage device 301, the host device 200 may transmit an isolation identifier IID corresponding to the write data WDT to the storage device 301. The storage device 301 only performs address mapping to correspond to the isolation identifier IID, and the generation and management of the isolation identifier IID are led by the file system FS of the host device 200. This host-driven data isolation storage may be efficiently applied without changing the existing storage standard. Therefore, the host-driven data isolation storage according to the example embodiments may be easily applied to storage systems adopting various standards.

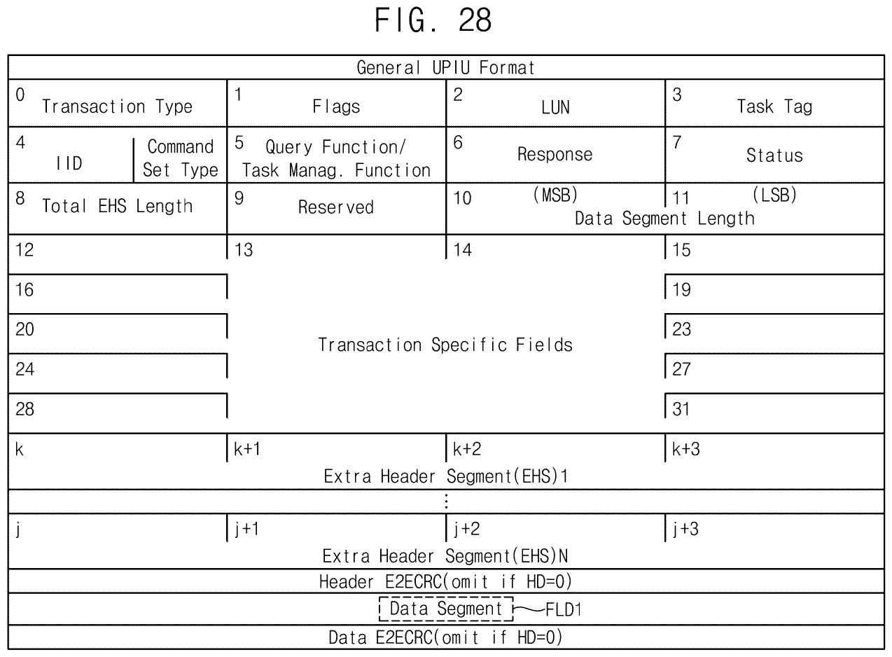

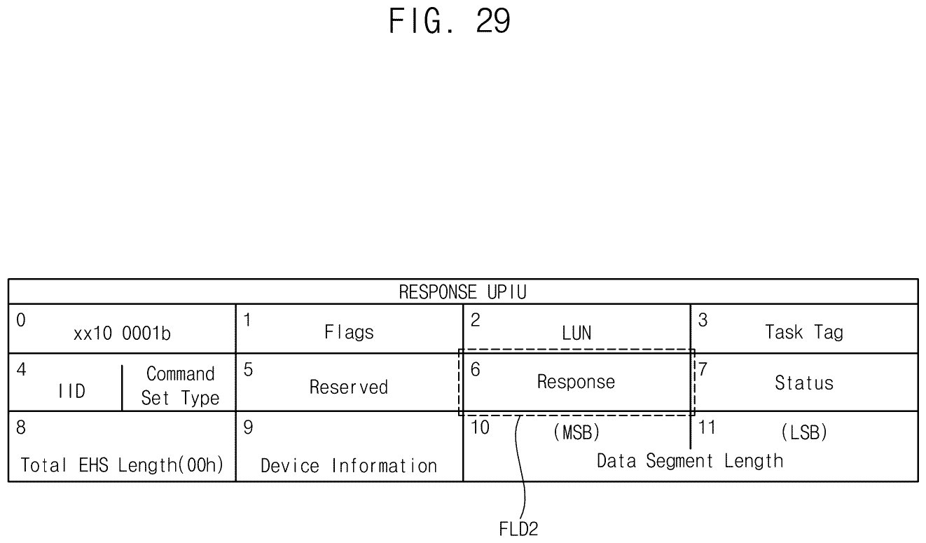

FIGS. 28 and 29 are diagrams illustrating a UFS Protocol Information Unit (UPIU) used in a storage system according to example embodiments.

FIG. 28 illustrates a generic format of a UPIU according to the UFS standard. The UPIU includes a plurality of fields, and FIG. 28 shows the byte number (0 to j+3) and name for each field. For example, the UPIU may include fields such as Transaction Type, Flags, LUN, Task Tag, IID, Command Set Type, Query Function/Task Manag. Function, Response, Total EHS Length (00h), Device Information, Data Segment Length, Transaction Specific Fields, Extra Header Segment (EHS)1 to Extra Header Segment (EHS)N, Header E2ECRC, Data Segment, Data E2ECRC, etc. The descriptions for each of these fields are replaced with descriptions specified in the UFS standard.

The host device 200 may transfer the synchronous move request SMREQ described above to the storage device 301 using a UPIU in accordance with the UFS standard as shown in FIG. 28. For example, the write data WDT above described may be included in the data segment field FLD1.

FIG. 29 illustrates a header portion of a response UPIU according to the UFS standard. The storage device 301 may transfer the aforementioned response RSP to the host device 200 using the response UPIU according to the UFS standard as shown in FIG. 29. For example, the response value SS of FIG. 5 may be included in the Response field FLD2 of the response UPIU.

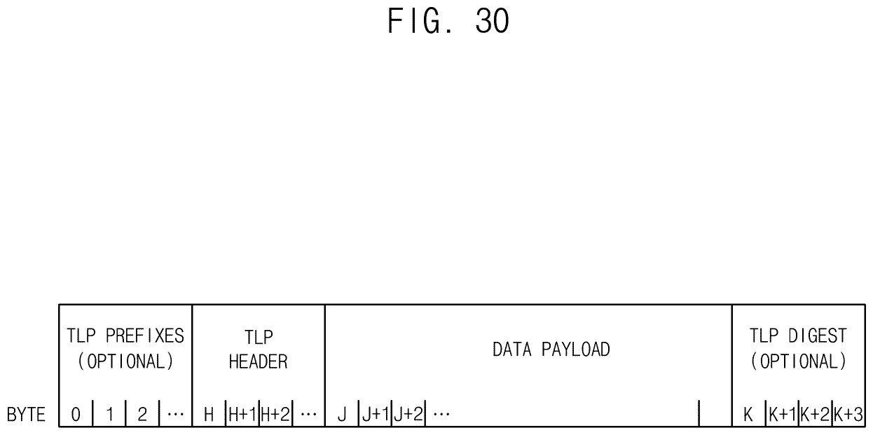

FIG. 30 is a diagram illustrating an example embodiment of a packet used in a storage system according to example embodiments.

FIG. 30 illustrates the format of a transaction layer packet (TLP) generated and managed by the transaction layer of a PCIe architecture.

Transactions include requests and completions (or responses) and are communicated using packets. As shown in FIG. 20, a transaction layer packet (TLP) may include fields such as an optional one or more TLP prefixes of a plurality of bytes (BYTE 0 to k+3), a TLP header, a data payload, and an optional digest.

The requests CRREQ, CWREQ and MWREQ and the responses CRRES, CWRES and MWRES described above with reference to FIG. 5 may correspond to the transaction layer packets TLP as illustrated in FIG. 30. The TLP header may include various information such as a device identifier, a response value indicating success or failure of various operations, and a data payload may include the write data WDT.

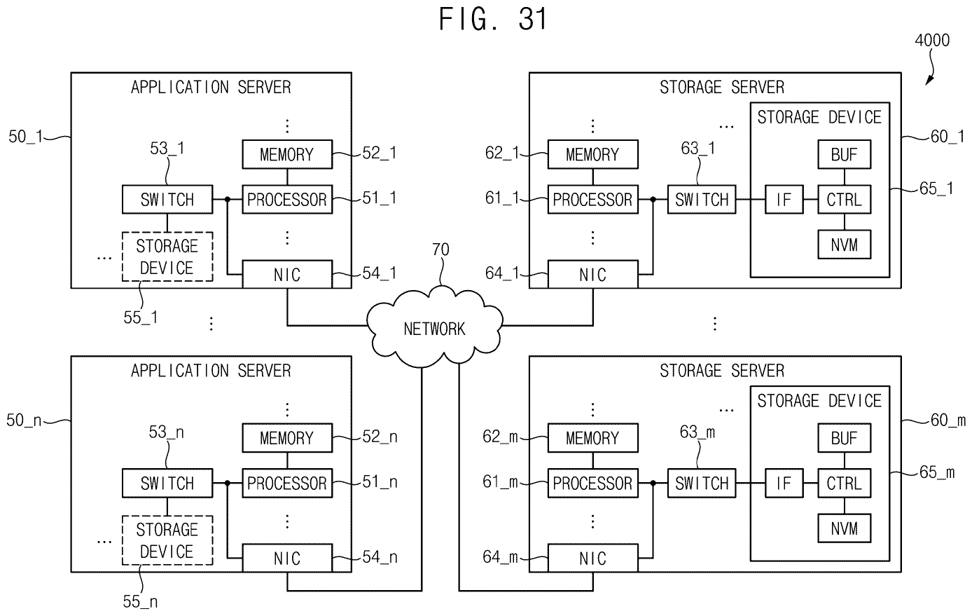

FIG. 31 is a block diagram illustrating a data center including a storage system according to example embodiments.

Referring to FIG. 31, the data center 4000 may collect various pieces of data and provide services and be also referred to as a data storage center. For example, the data center 4000 may be a system configured to operate a search engine and a database or a computing system used by companies, such as banks, or government agencies. As shown in FIG. 31, the data center 4000 may include application servers 50_1 to 50_n and storage servers 60_1 to 60_m (where, each of m and n is an integer more than 1). The number n of application servers 50_1 to 50_n and the number m of storage servers 60_1 to 60_m may be variously selected according to example embodiments. In some example embodiments, the number n of application servers 50_1 to 50_n may be different from the number m of storage servers 60_1 to 60_m.

The application servers 50_1 to 50_n may include any one or any combination of processors 51_1 to 51_n, memories 52_1 to 52_n, switches 53_1 to 53_n, network interface controllers (NICs) 54_1 to 54_n, and storage devices 55_1 to 55_n. The processors 51_1 to 51_n may control all operations of the application servers 50_1 to 50_n, access the memories 52_1 to 52_n, and execute instructions and/or data loaded in the memories 52_1 to 52_n. Non-limiting examples of the memories 52_1 to 52_n may include DDR SDRAM, a high-bandwidth memory (HBM), a hybrid memory cube (HMC), a dual in-line memory module (DIMM), an Optane DIMM, or a nonvolatile DIMM (NVDIIMM).

According to example embodiments, the numbers of processors and memories included in the application servers 50_1 to 50_n may be variously selected according to example embodiments. In some example embodiments, the processors 51_1 to 51_n and the memories 52_1 to 52_n may provide processor-memory pairs. In some example embodiments, the number of processors 51_1 to 51_n may be different from the number of memories 52_1 to 52_n. The processors 51_1 to 51_n may include a single core processor or a multi-core processor. In some example embodiments, as illustrated with a dashed line in FIG. 31, the storage devices 55_1 to 55_n may be omitted from the application servers 50_1 to 50_n. The number of storage devices 55_1 to 55_n included in the storage servers 50_1 to 50_n may be variously selected according to example embodiments. The processors 51_1 to 51_n, the memories 52_1 to 52_n, the switches 53_1 to 53_n, the NICs 54_1 to 54_n, and/or the storage devices 55_1 to 55_n may communicate with each other through a link described above with reference to the drawings.

The storage servers 60_1 to 60_m may include any one or any combination of processors 61_1 to 61_m, memories 62_1 to 62_m, switches 63_1 to 63_m, network interface controllers (NICs) 64_1 to 64_n, and storage devices 65_1 to 65_m. The processors 61_1 to 61_m and the memories 62_1 to 62_m may operate similar to the processors 51_1 to 51_n and the memories 52_1 to 52_n of the application servers 50_1 to 50_n described above.

The application servers 50_1 to 50_n may communicate with the storage servers 60_1 to 60_m through a network 70. In some example embodiments, the network 70 may be implemented using a fiber channel (FC) or Ethernet. The FC may be a medium used for relatively high-speed data transfer. An optical switch that provides high performance and high availability may be used as the FC. The storage servers 60_1 to 60_m may be provided as file storages, block storages, or object storages according to an access method of the network 70.

In some example embodiments, the network 70 may be a storage-only network, such as a storage area network (SAN). For example, the SAN may be an FC-SAN, which may use an FC network and be implemented using an FC Protocol (FCP). In another case, the SAN may be an Internet protocol (IP)-SAN, which uses a transmission control protocol/Internet protocol (TCP/IP) network and is implemented according to an SCSI over TCP/IP or Internet SCSI (iSCSI) protocol. In some example embodiments, the network 70 may be a general network, such as a TCP/IP network. For example, the network 70 may be implemented according to a protocol, such as FC over Ethernet (FCoE), network attached storage (NAS), nonvolatile memory express (NVMe) over fabrics (NVMe-oF).

The application server 50_1 and the storage server 60_1 will mainly be described, but it may be noted that a description of the application server 50_1 may be also applied to another application server (e.g., 50_n), and a description of the storage server 60_1 may be also applied to another storage server (e.g., 60_m).

The application server 50_1 may store data, which is requested to be stored by a user or a client, in one of the storage servers 60_1 to 60_m through the network 70. In some example embodiments, the application server 50_1 may obtain data, which is requested to be read by the user or the client, from one of the storage servers 60_1 to 60_m through the network 70. For example, the application server 50_1 may be implemented using a web server or a database management system (DBMS).

The application server 50_1 may access the memory 52_n and/or the storage device 55_n included in another application server 50_n, through the network 70, and/or access the memories 62_1 to 62_m and/or the storage devices 65_1 to 65_m included in the storage servers 60_1 to 60_m, through the network 70. Accordingly, the application server 50_1 may perform various operations on data stored in the application servers 50_1 to 50_n and/or the storage servers 60_1 to 60_m. For example, the application server 50_1 may execute an instruction to migrate or copy data between the application servers 50_1 to 50_n and/or the storage servers 60_1 to 60_m. In this case, the data may be migrated from the storage devices 65_1 to 65_m of the storage servers 60_1 to 60_m to the memories 52_1 to 52_n of the application servers 50_1 to 50_n through the memories 62_1 to 62_m of the storage servers 60_1 to 60_m or directly. In some example embodiments, the data migrated through the network 70 may be encrypted data for security or privacy.

In the storage server 60_1, an interface IF may provide physical connection between the processor 61_1 and a controller CTRL and physical connection between the NIC 64_1 and the controller CTRL. For example, the interface IF may be implemented using a direct attached storage (DAS) method in which the storage device 65_1 is directly connected to a dedicated cable. For example, the interface IF may be implemented using various interface methods, such as advanced technology attachment (ATA), serial ATA (SATA), external SATA (e-SATA), small computer small interface (SCSI), serial attached SCSI (SAS), PCI, PCIe, NVMe, IEEE 1394, a universal serial bus (USB), a secure digital (SD) card, a multi-media card (MMC), an embedded MMC (eMMC), a UFS, an embedded UFS (eUFS), and/or a compact flash (CF) card interface.

In the storage server 60_1, the switch 63_1 may selectively connect the processor 61_1 to the storage device 65_1 or selectively connect the NIC 64_1 to the storage device 65_1 based on the control of the processor 61_1.

In some example embodiments, the network interface controller (NIC) 64_1 may include a network interface card and a network adaptor. The NIC 54_1 may be connected to the network 70 through a wired interface, a wireless interface, a Bluetooth interface, or an optical interface. The NIC 54_1 may include an internal memory, a digital signal processor (DSP), and a host bus interface and be connected to the processor 61_1 and/or the switch 63_1 through the host bus interface. In some example embodiments, the NIC 64_1 may be integrated with any one or any combination of the processor 61_1, the switch 63_1, and the storage device 65_1.

In the application servers 50_1 to 50_n or the storage servers 60_1 to 60_m, the processors 51_1 to 51_m and 61_1 to 61_n may transmit commands to the storage devices 55_1 to 55_n and 65_1 to 65_m or the memories 52_1 to 52_n and 62_1 to 62_m and program or read data. In this case, the data may be data of which an error is corrected by an error correction code (ECC) engine. The data may be data processed with data bus inversion (DBI) or data masking (DM) and include cyclic redundancy Code (CRC) information. The data may be encrypted data for security or privacy.

In response to read commands received from the processors 51_1 to 51_m and 61_1 to 61_n, the storage devices 55_1 to 55_n and 65_1 to 65_m may transmit control signals and command/address signals to a nonvolatile memory device (e.g., a NAND flash memory device) NVM. Accordingly, when data is read from the nonvolatile memory device NVM, a read enable signal may be input as a data output control signal to output the data to a DQ bus. A data strobe signal may be generated using the read enable signal. The command and the address signal may be latched according to a rising edge or falling edge of a write enable signal.

The controller CTRL may control all operations of the storage device 65_1. In example embodiments, the controller CTRL may include static RAM (SRAM). The controller CTRL may write data to the nonvolatile memory device NVM in response to a write command or read data from the nonvolatile memory device NVM in response to a read command. For example, the write command and/or the read command may be generated based on a request provided from a host (e.g., the processor 61_1 of the storage server 60_1, the processor 61_m of another storage server 60_m, or the processors 51_1 to 51_n of the application servers 50_1 to 50_n). A buffer BUF may temporarily store (or buffer) data to be written to the nonvolatile memory device NVM or data read from the nonvolatile memory device NVM. In some example embodiments, the buffer BUF may include DRAM. The buffer BUF may store metadata. The metadata may refer to user data or data generated by the controller CTRL to manage the nonvolatile memory device NVM. The storage device 65_1 may include a secure element (SE) for security or privacy.

As described above, the storage system and the method of operating the storage system according to example embodiments may efficiently reduce data fragmentation through host-driven data isolation storage such that the file allocation instances are generated and managed by the file system of the host device. Through the host device-driven data isolation storage, a larger number of isolation spaces may be allocated than the isolation storage spaces provided by the storage device. By reducing data fragmentation, the efficiency of data access and the efficiency of garbage collection may be improved, thereby improving the performance and lifespan of the storage device.

As will be appreciated by one skilled in the art, example embodiments may be implemented as a system, method, computer program product, or a computer program product embodied in one or more computer readable medium(s) having computer readable program code embodied thereon. The computer readable program code may be provided to a processor of a general purpose computer, special purpose computer, or other programmable data processing apparatus. The computer readable medium may be a computer readable signal medium or a computer readable storage medium. The computer readable storage medium may be any tangible medium that may contain, or store a program for use by or in connection with an instruction execution system, apparatus, or device.

The various example embodiments may be applied to any electronic devices and systems including a nonvolatile memory device. For example, the various example embodiments may be applied to systems such as a memory card, a solid state drive (SSD), an embedded multimedia card (eMMC), a universal flash storage (UFS), a mobile phone, a smart phone, a personal digital assistant (PDA), a portable multimedia player (PMP), a digital camera, a camcorder, a personal computer (PC), a server computer, a workstation, a laptop computer, a digital TV, a set-top box, a portable game console, a navigation system, a wearable device, an internet of things (IoT) device, an internet of everything (IoE) device, an e-book, a virtual reality (VR) device, an augmented reality (AR) device, a server system, a data center, an automotive driving system, etc.

The foregoing is illustrative of various example embodiments and is not to be construed as limiting thereof. Although a few example embodiments have been described, those skilled in the art will readily appreciate that many modifications are possible in the example embodiments without materially departing from the scope as defined by the appended claims.

What is claimed is:

1. A storage system comprising:
a storage device including a nonvolatile memory device configured to store data and a storage controller configured to control the nonvolatile memory device to isolate and store the data by grouping a storage space of the nonvolatile memory device into a plurality of isolation storage spaces; and
a host device including a file system configured to generate and manage a plurality of file allocation instances corresponding to a plurality of file allocation system calls from application programs by allocating a logical address range and an isolation identifier of a plurality of isolation identifiers corresponding to the plurality of isolation storage spaces, with respect to each file allocation system call of the plurality of file allocation system calls.

2. The storage system of claim 1, wherein each file allocation instance of the plurality of file allocation instances include a file identifier, an allocated logical address range and an allocated isolation identifier.

3. The storage system of claim 2, wherein the host device is not to transfer the plurality of file allocation instances to the storage device, and configured to transfer an isolation identifier corresponding to write data that is to be stored in the storage device.

4. The storage system of claim 2, wherein the host device is configured to transfer a write request including write data, a write logical address, and a write isolation identifier corresponding to the write logical address based on the plurality of file allocation instances, and
wherein the storage device is configured to store the write data in an isolation storage space corresponding to the write isolation identifier included in the write request.

5. The storage system of claim 1, wherein the file system includes a first mapping table indicating a mapping relationship between the plurality of isolation identifiers and the plurality of file allocation instances.

6. The storage system of claim 5, wherein a file translation layer of the storage device includes:
a second mapping table indicating a mapping relationship between the plurality of isolation identifiers and memory blocks of the nonvolatile memory device; and
a third mapping table indicating a mapping relationship between logical addresses of the host device and physical addresses of the nonvolatile memory device.

7. The storage system of claim 1, wherein the file system is configured to determine whether to merge two or more file allocation instances corresponding to one file, based on a file attribute of the one file.

8. The storage system of claim 7, wherein the file attribute includes at least one of a file name of the one file, a file name extension of the one file, a file size of the one file, and update periods of data corresponding to the two or more file allocation instances.

9. The storage system of claim 1, wherein the file system is configured to determine whether to assign a same isolation identifier to two or more file allocation system calls corresponding to two or more files, based on file attributes of the two or more files.

10. The storage system of claim 1, wherein the file system is configured to, when receiving a new file allocation system call from an application program, determine whether to merge a new file allocation instance corresponding to the new file allocation system call with a previously generated file allocation instance.

11. The storage system of claim 1, wherein the file system is configured to, when receiving a new file allocation system call from an application program, determine whether an isolation identifier allocable to the new file allocation system call is available.

12. The storage system of claim 11, wherein the file system is configured to, when an isolation identifier allocable to the new file allocation system call is unavailable, delete an eviction file allocation instance among previously generated file allocation instances and generate a new file allocation instance by allocating an isolation identifier of the eviction file allocation instance with respect to the new file allocation system call.

13. The storage system of claim 1, wherein the file system is configured to generate and manage a first list that stores file allocation instances whose write operations are not completed in an order of a last write operation being performed, and a second list that stores file allocation instances whose write operations are completed in an order of a last write operation being performed.

14. The storage system of claim 13, wherein the file system is configured to, based on the first list and the second list, determine a file allocation instance whose last write operation was performed least recently among the file allocation instances whose write operations are completed, as an eviction file allocation instance to be deleted.

15. The storage system of claim 1, wherein the file system is configured to generate and manage eviction values with respect to the plurality of file allocation instances according to a following expression, and determine, among the plurality of file allocation instances, a file allocation instance having the largest eviction value as an eviction file allocation instance to be deleted,
$$Ve = W 1 \times Rw + W 2 \times Tw$$
where Ve is the eviction value of each file allocation instance, Rw is a ratio of an address range where a write operation is completed with respect to a logical address range allocated to each file allocation instance, Tw is a time elapsed from a time when a last write operation is performed with respect to each file allocation instance, and W1 and W2 are weight values.

16. The storage system of claim 1, wherein the file system is configured to, when receiving a new file allocation system call from an application program, determine whether to merge a new file allocation instance corresponding to the new file allocation system call with a previously generated file allocation instance, or delete an eviction file allocation instance among previously generated file allocation instances to generate a new file allocation instance by allocating an isolation identifier of the eviction file allocation instance with respect to the new file allocation system call.

17. The storage system of claim 1, wherein the file system is configured to, when receiving a system call to delete one file from an application program, delete all file allocation instances corresponding to the one file among previously generated file allocation instances.

18. The storage system of claim 1, wherein the file system is configured to, when receiving a system call to delete allocation of a target logical address range from an application program, delete all file allocation instances corresponding to an allocated logical address range that is included in the target logical address range.

19. A method of operating a storage system, comprising:
receiving, by a file system of a host device, a plurality of file allocation system calls from application programs;
allocating, by the file system, a logical address range, with respect to each file allocation system call of the plurality of file allocation system calls;
allocating, by the file system, an isolation identifier of a plurality of isolation identifiers corresponding to a plurality of isolation storage spaces of a storage device, with respect to each file allocation system call;
generating, by the file system, a file allocation instance including an allocated logical address range and an allocated isolation identifier, with respect to each file allocation system call;
transferring, from the host device to the storage device, a write request including write data, a write logical address, and a write isolation identifier corresponding to the write logical address based on a plurality of file allocation instances corresponding to the plurality of file allocation system calls; and
storing, by the storage device, the write data in an isolation storage space corresponding to the write isolation identifier included in the write request.

20. A storage system comprising:
a storage device including a nonvolatile memory device configured to store data and a storage controller configured to control the nonvolatile memory device to isolate and store the data by grouping a storage space of the nonvolatile memory device into a plurality of isolation storage spaces; and
a host device including a file system configured to generate and manage a plurality of file allocation instances corresponding to a plurality of file allocation system calls from application programs by allocating a logical address range and an isolation identifier of a plurality of isolation identifiers corresponding to the plurality of isolation storage spaces, with respect to each file allocation system call of the plurality of file allocation system calls,
wherein the host device is not to transfer the plurality of file allocation instances to the storage device, and configured to transfer an isolation identifier corresponding to write data that is to be stored in the storage device, and
wherein the storage device is configured to store the write data in an isolation storage space corresponding to a write isolation identifier transferred from the host device.
